(19) United States
(12) Patent Application Publication
(10) Pub. No.: US 2024/0047829 A1
(43) Pub. Date: Feb. 8, 2024

(54) SECONDARY BATTERY

(71) Applicant: MURATA MANUFACTURING CO., LTD., Kyoto (JP)

(72) Inventors: Takamasa ONO, Kyoto (JP); Masaki KURATSUKA, Kyoto (JP); Takashige FUJIKAWA, Kyoto (JP); Takeo ASANUMA, Kyoto (JP); Ami ONUMA, Kyoto (JP); Kazuya MAYUMI, Kyoto (JP); Masumi FUKUDA, Kyoto (JP); Yosuke KONO, Kyoto (JP); Atsushi OUKI, Kyoto (JP); Ippei WAKI, Kyoto (JP); Sho TAKAHASHI, Kyoto (JP)

(21) Appl. No.: 18/380,036

(22) Filed: Oct. 13, 2023

Related U.S. Application Data
(63) Continuation of application No. PCT/JP2022/006457, filed on Feb. 17, 2022.

(30) Foreign Application Priority Data
Apr. 23, 2021 (JP) 2021-073126

(51) Int. Cl. H01M 50/489; H01M 10/0525; H01M 50/443; H01M 50/426; H01M 10/0569; H01M 4/525; H01M 50/105; H01M 50/131

(52) U.S. Cl. CPC H01M 50/489; H01M 10/0525; H01M 50/443; H01M 50/426; H01M 10/0569; H01M 4/525; H01M 50/105; H01M 50/131; H01M 2004/028

(57) ABSTRACT

A secondary battery includes a positive electrode, a negative electrode, and a separator. The separator is interposed between the positive electrode and the negative electrode. The separator includes a porous layer, a first adhesion layer, and a second adhesion layer. The first adhesion layer is provided between the porous layer and the positive electrode, and is adhered to the positive electrode. The second adhesion layer is provided between the porous layer and the negative electrode, and is adhered to the negative electrode. After the separator is heated at a heating temperature of 130° C.±5° C. for a heating time of one hour, an adhesion strength of the first adhesion layer with respect to the positive electrode is larger than an adhesion strength of the first adhesion layer with respect to the porous layer, and an adhesion strength of the second adhesion layer with respect to the negative electrode is larger than an adhesion strength of the second adhesion layer with respect to the porous layer. After the separator is heated at a heating temperature of 130° C.±5° C. for a heating time of one hour, a softening temperature of the porous layer is lower than a softening temperature of the first adhesion layer, and is lower than a softening temperature of the second adhesion layer.

### CROSS REFERENCE TO RELATED APPLICATIONS

The present application is a continuation of PCT patent application no. PCT/JP2022/006457, filed on Feb. 17, 2022, which claims priority to Japanese patent application no. 2021-073126, filed on Apr. 23, 2021, the entire contents of which are incorporated herein by reference.

### BACKGROUND

The present technology relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode and a negative electrode that are opposed to each other with a separator interposed therebetween. A configuration of the secondary battery has been considered in various ways.

Specifically, a separator includes a porous layer, and a coating layer that covers a surface of the porous layer. The coating layer includes a polymer compound and inorganic particles, and the polymer compound includes a material such as polyvinylidene difluoride.

### SUMMARY

The present technology relates to a secondary battery.

Although consideration has been given in various ways regarding a configuration of a secondary battery, safety of the secondary battery is not sufficient yet. Accordingly, there is room for improvement in terms thereof.

It is therefore desirable to provide a secondary battery that makes it possible to achieve superior safety.

A secondary battery according to an embodiment of the present technology includes a positive electrode, a negative electrode, and a separator. The separator is interposed between the positive electrode and the negative electrode. The separator includes a porous layer, a first adhesion layer, and a second adhesion layer. The first adhesion layer is provided between the porous layer and the positive electrode, and is adhered to the positive electrode. The second adhesion layer is provided between the porous layer and the negative electrode, and is adhered to the negative electrode. After the separator is heated at a heating temperature of 130° C.±5° C. for a heating time of one hour, an adhesion strength of the first adhesion layer with respect to the positive electrode is larger than an adhesion strength of the first adhesion layer with respect to the porous layer, and an adhesion strength of the second adhesion layer with respect to the negative electrode is larger than an adhesion strength of the second adhesion layer with respect to the porous layer. After the separator is heated at a heating temperature of 130° C.±5° C. for a heating time of one hour, a softening temperature of the porous layer is lower than a softening temperature of the first adhesion layer, and is lower than a softening temperature of the second adhesion layer.

According to the secondary battery of an embodiment of the present technology, the separator includes the porous layer, the first adhesion layer adhered to the positive electrode, and the second adhesion layer adhered to the negative electrode, the respective adhesion strengths of the first adhesion layer and the second adhesion layer satisfy the above-described condition, and the respective softening temperatures of the porous layer, the first adhesion layer, and the second adhesion layer satisfy the above-described condition. Accordingly, it is possible to achieve superior safety.

Note that effects of the present technology are not necessarily limited to those described herein and may include any of a series of suitable effects in relation to the present technology.

### BRIEF DESCRIPTION OF THE FIGURES

FIG. 1 is a perspective view of a configuration of a secondary battery according to an embodiment of the present technology.

FIG. 2 is a sectional view of a configuration of a battery device illustrated in FIG. 1.

FIG. 3 is a sectional view of a detailed configuration of a separator illustrated in FIG. 2.

FIG. 4 is a block diagram illustrating a configuration of an application example of the secondary battery.

FIG. 5 is a perspective view of a configuration of a nickel piece to be used for a short-circuit test.

### DETAILED DESCRIPTION

One or more embodiments of the present technology are described below in further detail including with reference to the drawings.

A description is given first of a secondary battery according to an embodiment of the present technology.

The secondary battery to be described here is a secondary battery that obtains a battery capacity using insertion and extraction of an electrode reactant. The secondary battery includes a positive electrode, a negative electrode, a separator, and an electrolytic solution that is a liquid electrolyte.

The electrode reactant is not particularly limited in kind, and specific examples thereof include a light metal such as an alkali metal or an alkaline earth metal. Specific examples of the alkali metal include lithium, sodium, and potassium. Specific examples of the alkaline earth metal include beryllium, magnesium, and calcium.

Hereinafter, examples are given of a case where the electrode reactant is lithium. A secondary battery that obtains a battery capacity using insertion and extraction of lithium is what is called a lithium-ion secondary battery. In the lithium-ion secondary battery, lithium is inserted and extracted in an ionic state.

In this case, a charge capacity of the negative electrode is greater than a discharge capacity of the positive electrode. In other words, an electrochemical capacity per unit area of the negative electrode is set to be greater than an electrochemical capacity per unit area of the positive electrode. This is to prevent precipitation of the electrode reactant on a surface of the negative electrode during charging.

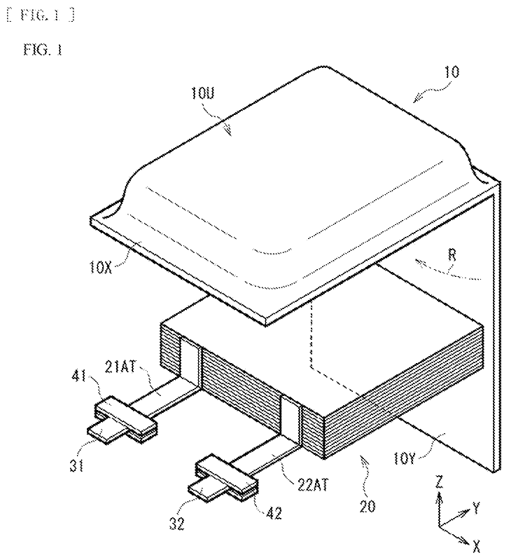

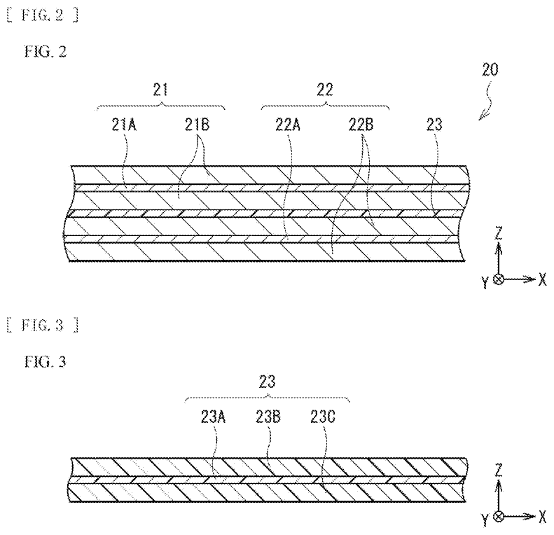

FIG. 1 illustrates a perspective configuration of the secondary battery. FIG. 2 illustrates a sectional configuration of a battery device 20 illustrated in FIG. 1. FIG. 3 illustrates a detailed sectional configuration of a separator 23 illustrated in FIG. 2. Note that FIG. 1 illustrates a state in which an outer package film 10 and the battery device 20 are separated from each other. FIG. 2 illustrates only a portion of the battery device 20, and the illustration of the separator 23 is simplified.

As illustrated in FIGS. 1 to 3, the secondary battery includes the outer package film 10, the battery device 20, a positive electrode lead 31, a negative electrode lead 32, and sealing films 41 and 42. The secondary battery described here is a secondary battery of a laminated-film type in which the outer package film 10 having flexibility or softness is used.

As illustrated in FIG. 1, the outer package film 10 is a flexible outer package member that contains the battery device 20. The outer package film 10 has a pouch-shaped structure that is sealed in a state where the battery device 20 is contained inside the outer package film 10. In other words, the outer package film 10 contains a positive electrode 21, a negative electrode 22, the separator 23, and an electrolytic solution that are to be described later.

Here, the outer package film 10 includes a pair of film members 10X and 10Y. The pair of film members 10X and 10Y serves as a pair of outer package parts that configures the outer package film 10. The film members 10X and 10Y are opposed to each other with the battery device 20 interposed therebetween.

Here, the film members 10X and 10Y are joined to each other, and are thus integrated with each other. Accordingly, the outer package film 10 is a single film that is continuous from the film member 10X to the film member 10Y. Note that the film members 10X and 10Y may be separated from each other, and may thus be provided separately from each other.

The outer package film 10 is folded in a folding direction R, and respective outer edge parts of the film members 10X and 10Y are bonded to each other. As a result, the outer package film 10 is sealed in a state in which the battery device 20 is contained therein as described above.

Note that one of the film member 10X or the film member 10Y has a depression part 10U to place the battery device 20 therein. The depression part 10U is what is called a deep drawn part. Here, the film member 10X has the depression part 10U.

Here, the outer package film 10 is a three-layered laminated film including a fusion-bonding layer, a metal layer, and a surface protective layer that are stacked in this order from an inner side. Accordingly, the fusion-bonding layer of the film member 10X and the fusion-bonding layer of the film member 10Y are opposed to each other in a state in which the outer package film is folded. The respective outer edge parts of the fusion-bonding layers are thus fusion-bonded to each other. The fusion-bonding layer includes a polymer compound such as polypropylene. The metal layer includes a metal material such as aluminum. The surface protective layer includes a polymer compound such as nylon.

Note that the outer package film 10 is not particularly limited in the number of layers, and may be single-layered or two-layered, or may include four or more layers.

Here, a bonding strength of the outer package film 10, in other words, a bonding strength at which the respective outer edge parts of the film members 10X and 10Y are bonded to each other, is not particularly limited.

In particular, a bonding strength FA of the outer package film 10 in a high-temperature environment is preferably within a predetermined range. Specifically, the bonding strength FA after the outer package film 10 is heated at a heating temperature of 140° C.±5° C. for a heating time of 0.5 hours is preferably smaller than or equal to 0.50 N/mm. A value of the bonding strength FA is rounded off to two decimal places.

A reason why the bonding strength FA is within the above-described range is that this suppresses occurrence of a short circuit during heating of the secondary battery.

In detail, as will be described later, the separator 23 includes an adhesion layer 23B. The adhesion layer 23B is adhered to the positive electrode 21, and is impregnated with the electrolytic solution. The adhesion layer 23B impregnated with the electrolytic solution has a low softening temperature as compared with a case where the adhesion layer 23B is not impregnated with the electrolytic solution. Accordingly, when the separator 23 is heated during the heating of the secondary battery, the adhesion layer 23B is easily peeled off from the positive electrode 21. If the adhesion layer 23B is peeled off from the positive electrode 21, a short circuit can occur due to contact between the positive electrode 21 and the negative electrode 22. Examples of the “heating of the secondary battery” include a case where the secondary battery is heated from an outside in a high-temperature environment, and a case where the secondary battery is heated from an inside due to heat generation of the battery device 20.

If the bonding strength FA is smaller than or equal to 0.50 N/mm in such a case, the film members 10X and 10Y are separated from each other in response to the heating when the separator 23 is heated. The outer package film 10 is thus intentionally cleaved (opened). The electrolytic solution is thereby discharged from the inside to the outside of the outer package film 10, and volatilized inside the outer package film 10. Further, the volatilization of the electrolytic solution is promoted with use of the outside air introduced into the inside from the outside of the outer package film 10, and the adhesion layer 23B is dried. Accordingly, a softening temperature of the adhesion layer 23B increases, which improves adherence of the adhesion layer 23B with respect to the positive electrode 21. As a result, the adhesion layer 23B easily remains on a surface of the positive electrode 21 without being peeled off from the positive electrode 21, in other words, a state in which the adhesion layer 23B having an insulating property is interposed between the positive electrode 21 and the negative electrode 22 is easily maintained. This suppresses occurrence of a short circuit.

Further, the intentional cleaving of the outer package film 10 in response to the heating causes a gas to be released from the inside to the outside of the outer package film 10 through a gap between the film members 10X and 10Y. The gas is generated inside the outer package film 10 due to, for example, a decomposition reaction of the electrolytic solution during the heating. This suppresses accumulation of the gas inside the outer package film 10, and thus also suppresses abnormal deformation of the outer package film 10 caused by the accumulation of the gas.

The bonding strength FA is controllable by a hot press condition in a fabrication process of the secondary battery, i.e., a thermal-fusion-bonding process of the film members 10X and 10Y, to be described later. The hot press condition may include, for example, a heating temperature, a pressing pressure, and a pressing time.

Here, a procedure of measuring the bonding strength FA is as described below. First, the secondary battery is disassembled to thereby collect the outer package film 10.

Thereafter, 10 test samples (10 mm×10 mm) are fabricated using the outer edge part of the outer package film 10, i.e., a portion where the film members 10X and 10Y are bonded to each other. In this case, the outer package film 10 is cut at any ten locations except where each of the film members 10X and 10Y overlaps each of the sealing films 41 and 42.

Thereafter, the test samples are stored (for a storing time of 0.5 hours) in a thermostatic chamber (at a temperature of 140° C.±5° C.). As a result, the test samples are heated (for a heating time of 0.5 hours). Thereafter, a peel strength (N/mm) of each of the ten test samples is measured by means of a tensile tester (a 180° tensile test method). In this case, the test samples are taken out from an inside of the thermostatic chamber, following which the peel strength is measured within 5 minutes, and a maximum value of the peel strength is identified by setting a tensile rate to 100 mm/min. Note that when the peel strength is to be measured, the film member 10Y may be peeled off from the film member 10X, or vice versa.

Lastly, the bonding strength FA is obtained by calculating an average value of the 10 peel strengths.

Note that the advantage obtainable by the adhesion layer 23B when the bonding strength FA is within the above-described range is also similarly obtainable by the adhesion layer 23C. That is, when the bonding strength FA is smaller than or equal to 0.5 N/mm, a softening temperature of the adhesion layer 23C increases even if the adhesion layer 23C is impregnated with the electrolytic solution, which improves adherence of the adhesion layer 23C with respect to the negative electrode 22. Accordingly, the adhesion layer 23C easily remains on a surface of the negative electrode 22 without being peeled off from the negative electrode 22, in other words, a state in which the adhesion layer 23C having an insulating property is interposed between the negative electrode 22 and the positive electrode 21 is easily maintained. This suppresses occurrence of a short circuit.

A bonding strength FB of the outer package film 10 in an ambient temperature environment is preferably within a predetermined range. Specifically, the bonding strength FB at a temperature of 25° C.±5° C. is preferably larger than or equal to 1.00 N/mm. As with the value of the bonding strength FA described above, a value of the bonding strength FB is rounded off to two decimal places.

A reason why the bonding strength FB is within the above-described range is that the bonding strength FB is sufficiently large in the ambient temperature environment, which makes it easier to maintain a state in which the film members 10X and 10Y are bonded to each other. This prevents the outer package film 10 from being unintentionally cleaved during normal use of the secondary battery other than during the heating.

As with the bonding strength FA described above, the bonding strength FB is also controllable by the hot press condition in the thermal-fusion-bonding process of the film members 10X and 10Y.

Here, a procedure of measuring the bonding strength FB is similar to the procedure of measuring the bonding strength FA described above except that the peel strength is measured in the ambient temperature environment (at a temperature of 25° C.±5° C.).

As illustrated in FIGS. 1 to 3, the battery device 20 is a power generation device that includes the positive electrode 21, the negative electrode 22, the separator 23, and the electrolytic solution (not illustrated). The battery device 20 is contained inside the outer package film 10.

Here, the battery device 20 is a stacked electrode body in which the positive electrode 21 and the negative electrode 22 are alternately stacked on each other with the separator 23 interposed therebetween. The positive electrode 21 and the negative electrode 22 are thus opposed to each other with the separator 23 interposed therebetween. Note that respective numbers of the positive electrode 21, the negative electrode 22, and the separator 23 to be stacked are not particularly limited, and may thus be set as desired. FIG. 1 illustrates a case where multiple positive electrodes 21 and multiple negative electrodes 22 are alternately stacked on each other with the separator 23 interposed therebetween.

The positive electrode 21 includes, as illustrated in FIG. 2, a positive electrode current collector 21A and a positive electrode active material layer 21B.

The positive electrode current collector 21A has two opposed surfaces on each of which the positive electrode active material layer 21B is to be provided. The positive electrode current collector 21A includes an electrically conductive material such as a metal material. Specific examples of the metal material include aluminum.

As illustrated in FIG. 1, the positive electrode current collector 21A includes a protruding part 21AT on which no positive electrode active material layer 21B is provided. Multiple protruding parts 21AT are joined to each other to have a lead shape. Here, the protruding part 21AT is integrated with a portion other than the protruding part 21AT. Note that the protruding part 21AT may be provided separately from the portion other than the protruding part 21AT, and may thus be joined to the portion other than the protruding part 21AT.

Here, the positive electrode active material layer 21B includes one or more of positive electrode active materials into which lithium is to be inserted and from which lithium is to be extracted. Note that the positive electrode active material layer 21B may further include one or more of other materials including, without limitation, a positive electrode binder and a positive electrode conductor.

Here, the positive electrode active material layer 21B is provided on each of the two opposed surfaces of the positive electrode current collector 21A. Note that the positive electrode active material layer 21B may be provided only on one of the two opposed surfaces of the positive electrode current collector 21A on a side where the positive electrode 21 is opposed to the negative electrode 22. A method of forming the positive electrode active material layer 21B is not particularly limited, and specifically includes one or more of methods including, without limitation, a coating method.

The positive electrode active material is not particularly limited in kind, and specific examples thereof include a lithium-containing compound. The lithium-containing compound is a compound that includes lithium and one or more transition metal elements as constituent elements. The lithium-containing compound may further include one or more other elements as one or more constituent elements. The one or more other elements are not particularly limited in kind as long as the one or more other elements are each an element other than lithium and the transition metal elements. Specifically, the one or more other elements are any one or more of elements belonging to groups 2 to 15 in the long period periodic table. The lithium-containing compound is not particularly limited in kind, and is specifically an oxide, a phosphoric acid compound, a silicic acid compound, or a boric acid compound, for example.

Specific examples of the oxide include LiNiO₂, LiCoO₂, LiCo_{0.98}Al_{0.01}Mg_{0.01}O₂, LiNi_{0.5}Co_{0.2}Mn_{0.302}, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

In particular, the positive electrode active material preferably includes one or more of lithium-nickel composite oxides represented by Formula (1) below. A reason for this is that this increases an energy density per unit volume and makes it possible to apply the secondary battery to high-power applications.

In detail, when a compound such as lithium cobalt oxide (LiCoO₂) that has a layered rock-salt crystal structure as with the lithium-nickel composite oxide but does not include nickel as a constituent element is used, an amount of heat generation increases during high-load discharging, which makes it difficult to apply the secondary battery to the high-power applications. Further, when a compound such as lithium iron phosphate (LiFePO₄) having an olivine crystal structure is used, a voltage decreases, which makes it difficult to increase the energy density per unit volume.

In contrast, using the lithium-nickel composite oxide prevents the amount of heat generation from increasing easily even during the high-load discharging, which makes it possible to apply the secondary battery to the high-power applications, and increases the voltage, which increases the energy density per unit volume. This achieves both an increase in the energy density per unit volume and applicability of the secondary battery to the high-power applications, and thus makes it possible to effectively apply the secondary battery to small-sized electronic equipment including, without limitation, mobile phones and power tools.

LiₓNi_{y}M_{1-y}O_{z} (1)

where:
M is at least one of Co, Mn, Mg, Al, B, Ti, V, Cr, Fe, Cu, Zn, Mo, Sn, Ca, Sr, or W, and
x, y, and z satisfy 0.8≤x≤1.2, 0.8≤y≤1.0, and 0<z<3.

As is apparent from Formula (1), the lithium-nickel composite oxide is a lithium composite oxide including nickel as a main component. In this case, as is apparent from a possible value range of “y” (or “1-y”), the lithium-nickel composite oxide may include an additional element (M) as a constituent element, or may not include the additional element as a constituent element.

In addition to LiNiO₂ and LiNi_{0.8}Co_{0.15}Al_{0.05}O₂ described above, specific examples of the lithium-nickel composite oxide include LiNi_{0.85}Co_{0.1}Al_{0.05}O₂, LiNi_{0.9}Co_{0.05}Al_{0.05}O₂, LiNi_{0.82}Co_{0.14}Al_{0.04}O₂, LiNi_{0.8}Co_{0.1}Mn_{0.1}O₂, and LiNi_{0.9}Co_{0.05}Mn_{0.05}O₂.

The positive electrode binder includes one or more of materials including, without limitation, a synthetic rubber and a polymer compound. Examples of the synthetic rubber include a styrene-butadiene-based rubber, a fluorine-based rubber, and ethylene propylene diene. Examples of the polymer compound include polyvinylidene difluoride, polyimide, and carboxymethyl cellulose.

In particular, when the adhesion layer 23B includes a homopolymer of vinylidene fluoride, a copolymer of vinylidene fluoride, or both, as will be described later, it is preferable that the positive electrode binder also similarly include the homopolymer of vinylidene fluoride, the copolymer of vinylidene fluoride, or both. A reason for this is that this improves the adherence of the adhesion layer 23B with respect to the positive electrode 21. Note that details of the homopolymer of vinylidene fluoride and details of the copolymer of vinylidene fluoride will be described later.

The positive electrode conductor includes one or more of electrically conductive materials including, without limitation, a carbon material. Examples of the carbon material include graphite, carbon black, acetylene black, and Ketjen black. Note that the electrically conductive material may be a metal material or a polymer compound, for example.

The negative electrode 22 includes, as illustrated in FIG. 2, a negative electrode current collector 22A and a negative electrode active material layer 22B.

The negative electrode current collector 22A has two opposed surfaces on each of which the negative electrode active material layer 22B is to be provided. The negative electrode current collector 22A includes an electrically conductive material such as a metal material. Specific examples of the metal material include copper.

As illustrated in FIG. 1, the negative electrode current collector 22A includes a protruding part 22AT on which no negative electrode active material layer 22B is provided. Multiple protruding parts 22AT are joined to each other to have a lead shape. Here, the protruding part 22AT is integrated with a portion other than the protruding part 22AT. Note that the protruding part 22AT may be provided separately from the portion other than the protruding part 22AT, and may thus be joined to the portion other than the protruding part 22AT.

Here, the negative electrode active material layer 22B includes one or more of negative electrode active materials into which lithium is to be inserted and from which lithium is to be extracted. Note that the negative electrode active material layer 22B may further include one or more of other materials including, without limitation, a negative electrode binder and a negative electrode conductor.

Here, the negative electrode active material layer 22B is provided on each of the two opposed surfaces of the negative electrode current collector 22A. Note that the negative electrode active material layer 22B may be provided only on one of the two opposed surfaces of the negative electrode current collector 22A on a side where the negative electrode 22 is opposed to the positive electrode 21. A method of forming the negative electrode active material layer 22B is not particularly limited, and specifically includes one or more of methods including, without limitation, a coating method, a vapor-phase method, a liquid-phase method, a thermal spraying method, and a firing (sintering) method.

The negative electrode active material is not particularly limited in kind, and specific examples thereof include a carbon material and a metal-based material. A reason for this is that a high energy density is obtainable. Specific examples of the carbon material include graphitizable carbon, non-graphitizable carbon, and graphite (natural graphite and artificial graphite). The metal-based material is a material that includes, as one or more constituent elements, one or more elements among metal elements and metalloid elements that are each able to form an alloy with lithium. Specific examples of such metal elements and metalloid elements include silicon, tin, or both. The metal-based material may be a simple substance, an alloy, a compound, a mixture of two or more thereof, or a material including two or more phases thereof. Specific examples of the metal-based material include TiSi₂ and SiOₓ (0≤x≤2 or 0.2<x<1.4). Needless to say, the negative electrode active material may be a mixture of the carbon material and the metal-based material.

Details of the negative electrode binder are similar to those of the positive electrode binder. Details of the negative electrode conductor are similar to those of the positive electrode conductor.

In particular, when the adhesion layer 23C includes the homopolymer of vinylidene fluoride, the copolymer of vinylidene fluoride, or both, as will be described later, it is preferable that the negative electrode binder also similarly include the homopolymer of vinylidene fluoride, the copolymer of vinylidene fluoride, or both. A reason for this is that this improves the adherence of the adhesion layer 23C with respect to the negative electrode 22.

As illustrated in FIGS. 2 and 3, the separator 23 is interposed between the positive electrode 21 and the negative electrode 22, and is adhered to the positive electrode 21 and the negative electrode 22. The separator 23 thus allows lithium ions to pass therethrough while preventing contact or a short circuit between the positive electrode 21 and the negative electrode 22.

As illustrated in FIG. 3, the separator 23 includes a porous layer 23A and the adhesion layers 23B and 23C. Note that, as described above, FIG. 2 illustrates the simplified configuration of the separator 23, and the respective illustrations of the porous layer 23A and the adhesion layers 23B and 23C are omitted.

The porous layer 23A has a porous structure and thus has multiple fine pores. The porous layer 23A includes one or more of insulating polymer compounds. Specific examples of the insulating polymer compound include polyethylene and polypropylene.

The porous layer 23A having the porous structure has what is called a shutdown function. The “shutdown function” is a function that causes some or all of the multiple fine pores to be blocked owing to thermal contraction of the porous layer 23A during the heating of the separator 23, and thus prevents the lithium ions from passing through the porous layer 23A. With use of the shutdown function, proceeding of charging and discharging reactions are forcibly stopped in the battery device 20 when an abnormality such as heating of the secondary battery occurs. This suppresses easy occurrence of thermal runaway of the battery device 20, thus preventing, for example, ignition, smoke generation, and damage of the secondary battery.

The adhesion layer 23B is a first adhesion layer disposed between the porous layer 23A and the positive electrode 21, and is adhered to the positive electrode 21. More specifically, the adhesion layer 23B is formed on one surface of the porous layer 23A, and is adhered to the positive electrode active material layer 21B of the positive electrode 21.

The adhesion layer 23B includes one or more of insulating polymer compounds. The insulating polymer compound is not particularly limited in kind, and specific examples thereof include the homopolymer of vinylidene fluoride and the copolymer of vinylidene fluoride. A reason for this is that this appropriately decreases the softening temperature of the adhesion layer 23B when the adhesion layer 23B is swollen (is turned into a gel) by the electrolytic solution. This improves the adherence of the adhesion layer 23B with respect to the positive electrode 21 in the fabrication process of the secondary battery, i.e., a thermocompression-bonding process of a stacked body, to be described later, which makes a distance between the positive electrode 21 and the negative electrode 22 uniform.

The homopolymer of vinylidene fluoride is what is called polyvinylidene difluoride. The copolymer of vinylidene fluoride is a copolymer of vinylidene fluoride and another monomer. The other monomer is not particularly limited in kind, and specific examples thereof include hexafluoropropylene, trifluoroethylene, tetrafluoroethylene, chlorotrifluoroethylene, and monomethyl maleate.

The adhesion layer 23C is a second adhesion layer disposed between the porous layer 23A and the negative electrode 22, and is adhered to the negative electrode 22. More specifically, the adhesion layer 23C is formed on an opposite surface of the porous layer 23A, i.e., a surface opposite to the surface on which the adhesion layer 23B is formed, and is adhered to the negative electrode active material layer 22B of the negative electrode 22.

The adhesion layer 23C includes one or more of insulating polymer compounds, and details of the insulating polymer compound are as described above. A reason for this is that this appropriately decreases the softening temperature of the adhesion layer 23C when the adhesion layer 23C is swollen by the electrolytic solution. This improves the adherence of the adhesion layer 23C with respect to the negative electrode 22 in the fabrication process of the secondary battery, i.e., the thermocompression-bonding process of the stacked body, which makes the distance between the negative electrode 22 and the positive electrode 21 uniform.

Note that the kind of the polymer compound included in the adhesion layer 23B and the kind of the polymer compound included in the adhesion layer 23C may be the same as or different from each other.

A reason why the separator 23 includes the adhesion layers 23B and 23C is that this improves the adherence of the separator 23 with respect to each of the positive electrode 21 and the negative electrode 22 as compared with a case where the separator 23 includes neither the adhesion layer 23B nor the adhesion layer 23C. This suppresses easy occurrence of positional displacement in the battery device 20, (i.e., displacement in terms of a positional relationship among the positive electrode 21, the negative electrode 22, and the separator 23), and thus preventing easy occurrence of swelling of the secondary battery even if the decomposition reaction of the electrolytic solution occurs. The “positional displacement” is what is called winding displacement in the battery device 20 that is a wound electrode body.

Note that the adhesion layer 23B may include one or more kinds of insulating particles. A reason for this is that this improves a characteristic of entering and exiting of the lithium ions into/from the adhesion layer 23B, and also improves the adherence of the adhesion layer 23B with respect to the positive electrode 21. Another reason for this is that the insulating particles promote heat dissipation when the secondary battery generates heat, thus improving heat resistance of the secondary battery.

The insulating particles are not particularly limited in kind, and examples thereof include inorganic particles and resin particles. The inorganic particles each include one or more of inorganic materials including, without limitation, aluminum oxide, aluminum nitride, boehmite, silicon oxide, titanium oxide, magnesium oxide, zirconium oxide, magnesium hydroxide, and talc. The resin particles each include one or more of resin materials including, without limitation, an acryl resin and a styrene resin.

A content of the insulating particles in the adhesion layer 23B is not particularly limited, and in particular, the content is preferably within a range from 30 vol % to 95 vol % both inclusive. A reason for this is that this sufficiently improves the characteristic of entering and exiting of the lithium ions into/from the adhesion layer 23B and also sufficiently improves the adherence of the adhesion layer 23B with respect to the positive electrode 21, while securing insulation resistance of the adhesion layer 23B.

In detail, if the content of the insulating particles is less than 30 vol %, a proportion of the insulating particles in the adhesion layer 23B is too small. Thus, insulation resistance of the adhesion layer 23B is not sufficiently large, and the characteristic of entering and exiting of the lithium ions may not be sufficiently improved. In contrast, if the content of the insulating particles is greater than or equal to 30 vol %, the proportion of the insulating particles in the adhesion layer 23B is sufficiently large. Thus, the insulation resistance of the adhesion layer 23B is sufficiently large, and the characteristic of entering and exiting of the lithium ions is sufficiently improved.

Further, if the content of the insulating particles is greater than 95 vol %, the proportion of the polymer compound in the adhesion layer 23B is too small. Thus, the adherence of the adhesion layer 23B with respect to the positive electrode 21 may not be sufficiently large. In contrast, if the content of the insulating particles is less than or equal to 95 vol %, the proportion of the polymer compound in the adhesion layer 23B is sufficiently large. Thus, the adherence of the adhesion layer 23B with respect to the positive electrode 21 is sufficiently large.

Note that the adhesion layer 23C may include, as with the adhesion layer 23B described above, one or more kinds of insulating particles. A reason for this is that this improves the characteristic of entering and exiting of the lithium ions into/from the adhesion layer 23C, and also improves the adherence of the adhesion layer 23C with respect to the negative electrode 22. Another reason for this is that the insulating particles promote heat dissipation when the secondary battery generates heat, thus improving the heat resistance of the secondary battery.

Details of a content of the insulating particles in the adhesion layer 23C are similar to those of the content of the insulating particles in the adhesion layer 23B described above. A reason for this is that this sufficiently improves the characteristic of entering and exiting of the lithium ions into/from the adhesion layer 23C and also sufficiently improves the adherence of the adhesion layer 23C with respect to the negative electrode 22, while securing insulation resistance of the adhesion layer 23C.

Note that the kind of the insulating particles included in the adhesion layer 23B and the kind of the insulating particles included in the adhesion layer 23C may be the same as or different from each other. Further, the content of the insulating particles in the adhesion layer 23B and the content of the insulating particles in the adhesion layer 23C may be the same as or different from each other.

Here, a procedure of calculating the content of the insulating particles in the adhesion layer 23B is as described below. First, the secondary battery is disassembled to thereby collect the separator 23, following which the separator 23 is cut with use of a cutting tool such as a diamond cutter to thereby expose a cross section thereof as illustrated in FIG. 3.

Thereafter, an elemental analysis is performed on the cross section of the adhesion layer 23B with use of a scanning electron microscopy/energy-dispersive X-ray spectroscopy (SEM-EDX). In this case, the elemental analysis regarding a constituent element of the polymer compound is performed to measure an area in which the polymer compound is present, and the elemental analysis regarding a constituent element of the insulating particles is performed to measure an area in which the insulating particles are present.

By way of example, if the polymer compound includes polyvinylidene difluoride and the insulating particles each include aluminum oxide, elemental analysis of fluorine is performed to measure the area in which the polymer compound is present, and the elemental analysis of aluminum is performed to measure the area in which the insulating particles are present.

Lastly, the content of the insulating particles is calculated based on the following calculation expression: content of insulating particles=[(area in which insulating particles are present×width of adhesion layer 23B)/(area in which polymer compound is present×width of adhesion layer 23B+ area in which insulating particles are present×width of adhesion layer 23B)]×100. The width of the adhesion layer 23B is a dimension of the adhesion layer 23B in a direction of a surface analysis using the SEM-EDX, i.e., in a Y-axis direction in FIG. 3.

Note that the procedure of calculating the content of the insulating particles in the adhesion layer 23C is similar to the procedure of calculating the content of the insulating particles in the adhesion layer 23B described above except that the elemental analysis is performed on a cross section of the adhesion layer 23C and that a width of the adhesion layer 23C is used for the calculation.

The secondary battery satisfies predetermined conditions (physical property conditions) regarding a physical property of the separator 23 in order to improve safety. Details of the physical property conditions will be described later.

The positive electrode 21, the negative electrode 22, and the separator 23 are each impregnated with the electrolytic solution, and the electrolytic solution includes a solvent and an electrolyte salt.

The solvent includes one or more of non-aqueous solvents (organic solvents). Examples of the non-aqueous solvent include a carbonic-acid-ester-based compound, a carboxylic-acid-ester-based compound, and a lactone-based compound. The electrolytic solution including the non-aqueous solvent(s) is what is called a non-aqueous electrolytic solution.

The carbonic-acid-ester-based compound is, for example, a cyclic carbonic acid ester or a chain carbonic acid ester. Specific examples of the cyclic carbonic acid ester include ethylene carbonate and propylene carbonate. Specific examples of the chain carbonic acid ester include dimethyl carbonate, diethyl carbonate, and ethyl methyl carbonate.

The carboxylic-acid-ester-based compound is, for example, a chain carboxylic acid ester. Specific examples of the chain carboxylic acid ester include methyl acetate, ethyl acetate, methyl trimethylacetate, methyl propionate, ethyl propionate, and propyl propionate.

The lactone-based compound is, for example, a lactone. Specific examples of the lactone include γ-butyrolactone and γ-valerolactone.

In particular, the solvent includes one or more of chain carboxylic acid esters, and a content of the one or more of chain carboxylic acid esters in the solvent is preferably within a range from 30 vol % to 60 vol % both inclusive. Specific examples of the chain carboxylic acid ester are as described above.

Reasons why the solvent includes the chain carboxylic acid ester and the content of the chain carboxylic acid ester in the solvent is within the above-described range are as follows. A first reason is that this suppresses, even if the positive electrode 21 includes the lithium-nickel composite oxide, generation of gas due to a reaction between the lithium-nickel composite oxide and the electrolytic solution. A second reason is that this prevents easy swelling of the adhesion layer 23B by the chain carboxylic acid ester, thus improving the characteristic of entering and exiting of the lithium ions into/from the adhesion layer 23B. A third reason is that this prevents easy swelling of the adhesion layer 23B by the chain carboxylic acid ester, thus preventing the softening temperature of the adhesion layer 23B from decreasing easily. Accordingly, the adherence of the adhesion layer 23B with respect to the positive electrode 21 is improved, which prevents the adhesion layer 23B from being peeled off easily from the positive electrode 21 when the secondary battery is heated.

Note that the advantages related to the adhesion layer 23B described above are also obtainable similarly for the adhesion layer 23C, thus improving the characteristic of entering and exiting of the lithium ions into/from the adhesion layer 23C and preventing the adhesion layer 23C from being peeled off easily from the negative electrode 22 when the secondary battery is heated.

The electrolyte salt includes one or more of light metal salts including, without limitation, a lithium salt.

Specific examples of the lithium salt include lithium hexafluorophosphate (LiPF₆), lithium tetrafluoroborate (LiBF₄), lithium bis(fluorosulfonyl)imide (LiN(FSO₂)₂), lithium bis(trifluoromethanesulfonyl)imide (LiN(CF₃SO₂)₂), lithium bis(oxalato)borate (LiB(C₂O₄)₂), lithium difluoro(oxalato)borate (LiB(C₂O₄)F₂), lithium monofluorophosphate (Li₂PFO₃), and lithium difluorophosphate (LiPF₂O₂).

A content of the electrolyte salt is not particularly limited, and is specifically within a range from 0.3 mol/kg to 3.0 mol/kg both inclusive with respect to the solvent. A reason for this is that high ion conductivity is obtainable.

As illustrated in FIG. 1, the positive electrode lead 31 is a positive electrode terminal coupled to the positive electrode current collector 21A of the positive electrode 21, and is led from an inside to an outside of the outer package film 10. The positive electrode lead 31 includes an electrically conductive material such as a metal material, and specific examples of the metal material include aluminum. The positive electrode lead 31 is not particularly limited in shape, and specifically has any of shapes including, without limitation, a thin plate shape and a meshed shape.

As illustrated in FIG. 1, the negative electrode lead 32 is a negative electrode terminal coupled to the negative electrode current collector 22A of the negative electrode 22, and is led from the inside to the outside of the outer package film 10. The negative electrode lead 32 includes an electrically conductive material such as a metal material, and specific examples of the metal material include copper. A direction in which the negative electrode lead 32 is led is not particularly limited, and is specifically led in a direction similar to that in which the positive electrode lead 31 is led. Details of a shape of the negative electrode lead 32 are similar to those of the shape of the positive electrode lead 31.

The sealing film 41 is interposed between the outer package film 10 and the positive electrode lead 31. The sealing film 42 is interposed between the outer package film 10 and the negative electrode lead 32. Note that the sealing film 41, the sealing film 42, or both may be omitted.

The sealing film 41 is a sealing member that prevents entry, for example, of outside air into the outer package film 10. The sealing film 41 includes a polymer compound such as a polyolefin that has adherence to the positive electrode lead 31. Specific examples of the polyolefin include polypropylene.

A configuration of the sealing film 42 is similar to that of the sealing film 41 except that the sealing film 42 is a sealing member that has adherence to the negative electrode lead 32. That is, the sealing film 42 includes a polymer compound such as a polyolefin that has adherence to the negative electrode lead 32.

As described below, the secondary battery satisfies a series of physical property conditions regarding the separator 23 in order to improve safety.

The separator 23 is heated under a condition of at a heating temperature of 130° C.±5° C. for a heating time of one hour (hereinafter referred to as a “heating condition”). After the separator 23 is heated, an adhesion strength F1 of the adhesion layer 23B with respect to the positive electrode 21 is larger than an adhesion strength F2 of the adhesion layer 23B with respect to the porous layer 23A. In other words, although the adhesion layer 23B is formed on the surface of the porous layer 23A, the adhesion layer 23B is more firmly adhered to the positive electrode 21 than to the porous layer 23A.

The adhesion strengths F1 and F2 are each controllable by a configuration of the adhesion layer 23B. Examples of the configuration of the adhesion layer 23B include a kind of the polymer compound, a weight average molecular weight of the polymer compound, presence or absence of the insulating particles, a kind of the insulating particles, and the content of the insulating particles in the adhesion layer 23B.

A reason why a large-and-small relationship between the adhesion strengths F1 and F2 based on after heating the separator 23 under the above-described heating condition is defined is that what is called a relationship between the adhesion strengths F1 and F2 of the adhesion layer 23B in a dry state is to be defined.

In detail, as described above, the separator 23 is impregnated with the electrolytic solution, and the adhesion layer 23B is impregnated with some of the electrolytic solution. The adhesion layer 23B is thus swollen by the electrolytic solution. Accordingly, because the adhesion layer 23B in a swollen state has a lower softening temperature than the adhesion layer 23B in the dry state, the adhesion strengths F1 and F2 of the adhesion layer 23B in the swollen state are respectively lower than the adhesion strengths F1 and F2 of the adhesion layer 23B in the dry state.

The first physical property condition therefore defines the relationship between the adhesion strengths F1 and F2 of the adhesion layer 23B in the dry state rather than in the swollen state, by heating the separator 23 under the above-described heating condition.

A reason why the adhesion strength F1 is larger than the adhesion strength F2 is that, even when the porous layer 23A undergoes thermal contraction during the heating of the secondary battery, the adhesion layer 23B remains on the surface of the positive electrode 21 without being peeled off from the positive electrode 21, and thus continues to be adhered to the positive electrode 21 even during the thermal contraction of the porous layer 23A. Accordingly, the porous layer 23A undergoes the thermal contraction, but the state in which the adhesion layer 23B is interposed between the positive electrode 21 and the negative electrode 22 is maintained. This prevents a short circuit between the positive electrode 21 and the negative electrode 22 with use of the adhesion layer 23B while securing the shutdown function of the porous layer 23A.

Here, a procedure of checking whether the adhesion strength F1 is larger than the adhesion strength F2 is as described below. First, the secondary battery is discharged until a voltage reaches 3.0 V in an ambient temperature environment (at a temperature of 20° C.±5° C. and a dew point of lower than or equal to −25° C.).

Thereafter, the secondary battery is put into a thermostatic chamber (at a temperature of 130° C.±5° C.), following which the secondary battery is stored in the thermostatic chamber (for a storing time of one hour). In this case, in order to prevent the secondary battery from coming into contact with a floor (a metal surface) in the thermostatic chamber, the secondary battery is placed on a mica plate inside the thermostatic chamber. Usable as the thermostatic chamber is a thermostatic chamber “SPHH-201” available from Espec Corporation. In this manner, the secondary battery is heated under the above-described heating condition. Thereafter, the secondary battery is taken out from the inside of the thermostatic chamber, following which the secondary battery is disassembled to thereby collect the positive electrode 21 and the separator 23.

Lastly, the elemental analysis is performed on the surface of the positive electrode 21 with use of the SEM-EDX described above to thereby determine the large-and-small relationship between the adhesion strengths F1 and F2 based on an adhesion status of the adhesion layer 23B.

Specifically, when a case where the adhesion layer 23B includes the insulating particles is given as an example, the large-and-small relationship between the adhesion strengths F1 and F2 is determined based on a distribution state of the insulating particles. That is, when the porous layer 23A is thermally contracted and thus the porous layer 23A is not present in a portion of a region on the surface of the positive electrode 21 but the insulating particles are present in the portion of the region, the porous layer 23A is peeled off from the adhesion layer 23B but the adhesion layer 23B is not peeled off from the positive electrode 21. It is therefore determined that the adhesion strength F1 is larger than the adhesion strength F2. In contrast, when the porous layer 23A is thermally contracted and thus the porous layer 23A is not present in a portion of the region on the surface of the positive electrode 21 and the insulating particles are not present in the portion of the region either, the porous layer 23A is peeled off from the adhesion layer 23B and the adhesion layer 23B is also peeled off from the positive electrode 21. It is therefore determined that the adhesion strength F1 is smaller than the adhesion strength F2.

Note that the first physical property condition (including the procedure of checking whether the adhesion strength F1 is larger than the adhesion strength F2) regarding the adhesion strengths F1 and F2 of the adhesion layer 23B is also applied similarly to adhesion strengths F3 and F4 of the adhesion layer 23C.

That is, after the separator 23 is heated under the above-described heating condition, the adhesion strength F3 of the adhesion layer 23C with respect to the negative electrode 22 is larger than the adhesion strength F4 of the adhesion layer 23C with respect to the porous layer 23A. In other words, although the adhesion layer 23C is formed on the surface of the porous layer 23A, the adhesion layer 23C is more firmly adhered to the negative electrode 22 than to the porous layer 23A.

The adhesion strengths F3 and F4 are each controllable by a configuration of the adhesion layer 23C. Details of the configuration of the adhesion layer 23C are similar to those of the configuration of the adhesion layer 23B described above. A reason why a large-and-small relationship between the adhesion strengths F3 and F4 is defined is that the relationship between the adhesion strengths F3 and F4 in the dry state rather than the swollen state is to be defined.

A reason why the adhesion strength F3 is larger than the adhesion strength F4 is that an advantage is obtainable that is similar to the advantage to be obtained when the adhesion strength F1 is larger than the adhesion strength F2. That is, even when the porous layer 23A undergoes thermal contraction during the heating of the secondary battery, the adhesion layer 23C continues to be adhered to the negative electrode 22. Accordingly, the porous layer 23A undergoes the thermal contraction, but the state in which the adhesion layer 23C is interposed between the negative electrode 22 and the positive electrode 21 is maintained. This prevents the short circuit between the negative electrode 22 and the positive electrode 21 with use of the adhesion layer 23C while securing the shutdown function of the porous layer 23A.

Note that a procedure of checking whether the adhesion strength F3 is larger than the adhesion strength F4 is similar to the procedure of checking whether the adhesion strength F1 is larger than the adhesion strength F2 described above except that the large-and-small relationship between the adhesion strengths F3 and F4 is determined based on an adhesion status of the adhesion layer 23C.

The separator 23 is heated under the heating condition of the first physical property condition described above. After the separator 23 is heated, a softening temperature T1 of the porous layer 23A is lower than a softening temperature T2 of the adhesion layer 23B.

The softening temperature T2 is controllable by the configuration of the adhesion layer 23B. As described above, examples of the configuration of the adhesion layer 23B include the kind of the polymer compound, the weight average molecular weight of the polymer compound, the presence or absence of the insulating particles, the kind of the insulating particles, and the content of the insulating particles in the adhesion layer 23B.

A reason why a high-and-low relationship between the softening temperatures T1 and T2 based on after heating the separator 23 under the above-described heating condition is defined is that a relationship between the softening temperature T1 of the porous layer 23A in the dry state and the softening temperature T2 of the adhesion layer 23B in the dry state is to be defined.

A reason why the softening temperature T1 is lower than the softening temperature T2 is that, during the heating of the secondary battery, the porous layer 23A more easily undergoes thermal contraction than the adhesion layer 23B, which makes it easier for the porous layer 23A to activate the shutdown function, and in addition, the adhesion layer 23B less easily undergoes thermal contraction than the porous layer 23A, which makes it less easy for the adhesion layer 23B to be peeled off from the positive electrode 21. This prevents the short circuit between the positive electrode 21 and the negative electrode 22 with use of the adhesion layer 23B while securing the shutdown function of the porous layer 23A.

Here, a procedure of identifying each of the softening temperatures T1 and T2 is as described below. First, the secondary battery is discharged until a voltage reaches 3.0 V in an ambient temperature environment (at a temperature of 20° C.±5° C. and a dew point of lower than or equal to −25° C.), following which the secondary battery is disassembled to thereby collect the separator 23.

Thereafter, the separator 23 is cut at 16 locations to obtain small pieces, following which the 16 pieces of separator 23 are stacked on each other. In this case, a portion of the separator 23 that is opposed to neither the positive electrode 21 nor the negative electrode 22, i.e., a portion of the separator 23 that is extended outward from each of the positive electrode 21 and the negative electrode 22, is cut. Thereafter, a stacked body of the separator 23 is cut in such a manner that the stacked body has a diameter of 0.5 mm to thereby fabricate a test sample.

Thereafter, the test sample is placed inside the outer package film 10, following which a solvent (propylene carbonate that is an organic solvent) is injected into the outer package film 10. Thereafter, the outer package film 10 is sealed in a reduced pressure environment (at a pressure of kPa), following which the outer package film 10 is left to stand (for a leaving time of 24 hours) to thereby impregnate the test sample with the solvent.

Thereafter, the test sample is taken out from the inside of the outer package film 10, following which the test sample is placed inside (in the middle) of a sapphire container (having an outer diameter of 5 mm and a height of 7 mm). Thereafter, 20 μL (=20×10⁻⁶ dm³) of solvent (propylene carbonate) is injected into the sapphire container, following which the sapphire container is left to stand (for a leaving time of one minute) in a reduced pressure environment (at a pressure of 10 kPa).

Lastly, vacuuming is performed, following which analysis on the test sample (the porous layer 23A and the adhesion layer 23B) is performed using thermomechanical analysis (TMA) to thereby measure each of the softening temperatures T1 and T2. Here, a thermomechanical analyzer “TMA7100”, available from Hitachi High-Tech Science Co., Ltd., is used (in which a measurement mode is a penetration mode, a tip diameter of a penetration probe is 0.5 mm, a heating rate is 5° C./min, a measurement temperature range is 25° C. to 150° C., and a load is 50 mN). Further, a position of the test sample is adjusted with respect to the penetration probe in such a manner that the test sample opposes the center of the penetration probe. When measuring each of the softening temperatures T1 and T2, an inflection point at which displacement increases in a swelling direction within a temperature range lower than each of the softening temperatures T1 and T2 is identified, following which a swelling-start temperature is determined based on the inflection point.

Note that the second physical property condition (including a procedure of checking whether the softening temperature T1 is lower than the softening temperature T2) regarding the softening temperature T1 of the porous layer 23A and the softening temperature T2 of the adhesion layer 23B is also applied similarly to the softening temperature T1 of the porous layer 23A and the softening temperature T3 of the adhesion layer 23C.

That is, after the separator 23 is heated under the above-described heating condition, the softening temperature T1 of the porous layer 23A is lower than the softening temperature T3 of the adhesion layer 23C.

The softening temperature T3 of the adhesion layer 23C is controllable by the configuration of the adhesion layer 23C. Details of the configuration of the adhesion layer 23C are similar to those of the configuration of the adhesion layer 23B described above.

A reason why a high-and-low relationship between the softening temperatures T1 and T3 based on after the heating under the above-described heating condition is defined is that a relationship between the softening temperature T1 of the porous layer 23A in the dry state and the softening temperature T3 of the adhesion layer 23C in the dry state is to be defined.

A reason why the softening temperature T1 is lower than the softening temperature T3 is that an advantage is obtainable that is similar to the advantage to be obtained when the softening temperature T1 is lower than the softening temperature T2. That is, a reason for this is that, during the heating of the secondary battery, it is easier for the porous layer 23A to activate the shutdown function, and it is less easy for the adhesion layer 23C to be peeled off from the negative electrode 22. This prevents the short circuit between the negative electrode 22 and the positive electrode 21 with use of the adhesion layer 23C while securing the shutdown function of the porous layer 23A.

Note that a procedure of identifying each of the softening temperatures T1 and T3 is similar to the procedure of identifying each of the softening temperatures T1 and T2 described above except that analysis on the test sample (the porous layer 23A and the adhesion layer 23C) is performed using the TMA.

Note that the adhesion layer 23B may satisfy a third physical property condition described below.

Specifically, after the separator 23 is impregnated with the solvent (propylene carbonate that is the organic solvent) under a condition that the impregnation time is 24 hours (hereinafter referred to as an “impregnation condition”), a softening temperature T4 of the adhesion layer 23B measured using the TMA is not particularly limited, and in particular, the softening temperature T4 is preferably higher than or equal to 70.0° C. A value of the softening temperature T4 is rounded off to one decimal place.

A reason why the softening temperature T4 based on after the separator 23 is impregnated with the solvent in the impregnation condition described above is defined is that the softening temperature T4 of the adhesion layer 23B in the swollen state is to be defined.

A reason why the softening temperature T4 is higher than or equal to 70.0° C. is that this improves the characteristic of entering and exiting of the lithium ions into/from the adhesion layer 23B.

In detail, when the softening temperature T4 is lower than 70.0° C., the softening temperature T4 is too low, which causes the adhesion layer 23B to soften easily during the heating of the secondary battery. When the adhesion layer 23B softens, what is called clogging tends to occur in the adhesion layer 23B, which can make it difficult for the lithium ions to pass through the adhesion layer 23B.

In contrast, when the softening temperature T4 is higher than or equal to 70.0° C., the softening temperature T4 is sufficiently high, which prevents the adhesion layer 23B from softening easily during the heating of the secondary battery. This prevents easy occurrence of the clogging in the adhesion layer 23B, which makes it easier for the lithium ions to pass through the adhesion layer 23B.

Here, a procedure of identifying the softening temperature T4 is as described below. First, the secondary battery is disassembled to thereby collect the separator 23. Thereafter, the solvent (propylene carbonate) is put in a container, following which the separator 23 is immersed in the solvent, and is left to stand (for a leaving time of 24 hours). The separator 23 is thus impregnated with the solvent (for an impregnation time of 24 hours). Lastly, the separator 23 is taken out from the solvent, following which the softening temperature T4 of the adhesion layer 23B is measured using the TMA.

Note that the third physical property condition (including the procedure of measuring the softening temperature T4) regarding the softening temperature T4 of the adhesion layer 23B is also applied similarly to a softening temperature T5 of the adhesion layer 23C. That is, the softening temperature T5 of the adhesion layer 23C measured using the TMA is not particularly limited, and in particular, the softening temperature T5 is preferably higher than or equal to 70° C. A reason for this is that this improves the characteristic of entering and exiting of the lithium ions into/from the adhesion layer 23C for a reason similar to that described in relation to the adhesion layer 23B.

Further, the adhesion layer 23B may satisfy a fourth physical property condition described below.

Specifically, the softening temperature T4 described above is not particularly limited, and in particular, the softening temperature T4 is preferably lower than or equal to 100.0° C. A reason for this is that this improves the adherence of the adhesion layer 23B with respect to the positive electrode 21.

In detail, when the softening temperature T4 is higher than 100.0° C., the softening temperature T4 is too high, which makes it difficult for the adhesion layer 23B to soften appropriately after the separator 23 is heated. The wording “after the separator 23 is heated” means, as will be described later, after the stacked body is pressed while being heated to cause the positive electrode 21, the negative electrode 22, and the separator 23 to be thermocompression-bonded in the fabrication process of the secondary battery. This makes it difficult for the adhesion layer 23B to be sufficiently adhered to the positive electrode 21, and thus the adherence of the adhesion layer 23B with respect to the positive electrode 21 may not increase sufficiently.

In contrast, when the softening temperature T4 is lower than or equal to 100.0° C., the softening temperature T4 is appropriately low, which makes it easier for the adhesion layer 23B to appropriately soften after the separator 23 is heated. This makes it sufficiently easier for the adhesion layer 23B to be adhered to the positive electrode 21, which sufficiently increases the adherence of the adhesion layer 23B with respect to the positive electrode 21.

Note that the fourth physical property condition (including the procedure of measuring the softening temperature T4) regarding the softening temperature T4 of the adhesion layer 23B is also applied similarly to the softening temperature T5 of the adhesion layer 23C. That is, the softening temperature T5 of the adhesion layer 23C measured using the TMA is not particularly limited, and in particular, the softening temperature T5 is preferably lower than or equal to 100° C. A reason for this is that this improves the adherence of the adhesion layer 23C with respect to the negative electrode 22 for a reason similar to that described in relation to the adhesion layer 23B.

Upon charging the secondary battery, in the battery device 20, lithium is extracted from the positive electrode 21, and the extracted lithium is inserted into the negative electrode 22 via the electrolytic solution. Upon discharging the secondary battery, in the battery device 20, lithium is extracted from the negative electrode 22, and the extracted lithium is inserted into the positive electrode 21 via the electrolytic solution. Upon charging and discharging, lithium is inserted and extracted in an ionic state.

In a case of manufacturing the secondary battery, the positive electrode 21 and the negative electrode 22 are fabricated and the electrolytic solution is prepared, following which the secondary battery is assembled and a stabilization process is performed on the assembled secondary battery, according to a procedure as an example to be described below.

First, a mixture (a positive electrode mixture) in which the positive electrode active material, the positive electrode binder, and the positive electrode conductor are mixed with each other is put into a solvent to thereby prepare a positive electrode mixture slurry in a paste form. The solvent may be an aqueous solvent, or may be an organic solvent. Details of the solvent described here apply also to the following. Thereafter, the positive electrode mixture slurry is applied on the two opposed surfaces of the positive electrode current collector 21A including the protruding part 21AT (but is not applied on the protruding part 21AT) to thereby form the positive electrode active material layers 21B. Lastly, the positive electrode active material layers 21B may be compression-molded by means of, for example, a roll pressing machine. In this case, the positive electrode active material layers 21B may be heated. The positive electrode active material layers 21B may be compression-molded multiple times. In this manner, the positive electrode active material layers 21B are formed on the respective two opposed surfaces of the positive electrode current collector 21A. Thus, the positive electrode 21 is fabricated.

The negative electrode 22 is formed by a procedure similar to the fabrication procedure of the positive electrode 21 described above. Specifically, first, a mixture (a negative electrode mixture) in which the negative electrode active material, the negative electrode binder, and the negative electrode conductor are mixed with each other is put into the solvent to thereby prepare a negative electrode mixture slurry in a paste form. Thereafter, the negative electrode mixture slurry is applied on the two opposed surfaces of the negative electrode current collector 22A including the protruding part 22AT (but is not applied on the protruding part 22AT) to thereby form the negative electrode active material layers 22B. Lastly, the negative electrode active material layers 22B are compression-molded. In this manner, the negative electrode active material layers 22B are formed on the respective two opposed surfaces of the negative electrode current collector 22A. Thus, the negative electrode 22 is fabricated.

A precursor solution including the polymer compound and a solvent is prepared, following which the precursor solution is applied on the two opposed surfaces of the porous layer 23A. In this case, insulating particles may be added to the precursor solution on an as-needed basis. In this manner, the adhesion layers 23B and 23C are formed on the respective two opposed surfaces of the porous layer 23A. Thus, the separator 23 is fabricated.

First, the positive electrode 21 and the negative electrode 22 are alternately stacked on each other with the separator 23 interposed therebetween to thereby fabricate a stacked body (not illustrated). The stacked body has a configuration similar to that of the battery device 20 except that the positive electrode 21, the negative electrode 22, and the separator 23 are each not impregnated with the electrolytic solution. Thereafter, the stacked body is pressed while being heated by means of, for example, a hot press machine. A direction of the pressing is a direction in which the positive electrode 21 and the negative electrode 22 are alternately stacked with the separator 23 interposed therebetween. The positive electrode 21, the negative electrode 22, and the separator 23 are thereby thermocompression-bonded to each other. Thus, the adhesion layer 23B is adhered to the positive electrode 21, and the adhesion layer 23C is adhered to the negative electrode 22.

Thereafter, multiple protruding parts 21AT are joined to each other by a method such as a welding method, and multiple protruding parts 22AT are joined to each other by a method such as a welding method. Thereafter, the positive electrode lead 31 is coupled to the joined multiple protruding parts 21AT by a method such as a welding method, and the negative electrode lead 32 is coupled to the joined multiple protruding parts 22AT by a method such as a welding method.

Thereafter, the stacked body is placed inside the depression part 10U, following which the outer package film 10 (the fusion-bonding layer/the metal layer/the surface protective layer) is folded to thereby cause the film members 10X and 10Y to be opposed to each other. Thereafter, respective outer edge parts of two sides of the film members 10X and 10Y (the fusion-bonding layers) are thermal-fusion-bonded to each other by means of, for example, a hot press machine. As a result, the respective outer edge parts of the film members 10X and 10Y are bonded to each other to thereby contain the stacked body in the outer package film 10 having the pouch shape.

Lastly, the electrolytic solution is injected into the outer package film 10 having the pouch shape, following which the respective outer edge parts of the remaining one side of the film members 10X and 10Y (the fusion-bonding layers) are thermal-fusion-bonded to each other by means of, for example, a hot press machine. In this case, the sealing film 41 is interposed between each of the film members 10X and 10Y and the positive electrode lead 31, and the sealing film 42 is interposed between each of the film members 10X and 10Y and the negative electrode lead 32.

In this manner, the stacked body is impregnated with the electrolytic solution, and the battery device 20 that is a stacked electrode body is thus fabricated. In addition, the film members 10X and 10Y are bonded to each other, and the outer package film 10 is thus formed. Accordingly, the battery device 20 is sealed in the outer package film 10 having the pouch shape. As a result, the secondary battery is assembled.

The assembled secondary battery is charged and discharged. Conditions including, for example, an environment temperature, the number of times of charging and discharging (the number of cycles), and charging and discharging conditions may be set as desired. A film is thereby formed on the surface of each of the positive electrode 21 and the negative electrode 22. This brings the secondary battery into an electrochemically stable state. As a result, the secondary battery is completed.

According to the secondary battery: the separator 23 includes the porous layer 23A, the adhesion layer 23B adhered to the positive electrode 21, and the adhesion layer 23C adhered to the negative electrode 22; the adhesion strengths F1 to F4 of the adhesion layers 23B and 23C satisfy the first physical property condition (F1>F2 and F3>F4); and the softening temperatures T1 to T3 of the porous layer 23A and the adhesion layers 23B and 23C satisfy the second physical property condition (T1<T2 and T1<T3).

In this case, as described above, even when the porous layer 23A undergoes thermal contraction during the heating of the secondary battery, the adhesion layer 23B remains on the surface of the positive electrode 21 without being peeled off from the positive electrode 21, and the adhesion layer 23C remains on the surface of the negative electrode 22 without being peeled off from the negative electrode 22. Accordingly, the state in which the adhesion layers 23B and 23C are interposed between the positive electrode 21 and the negative electrode 22 is maintained. This prevents a short circuit between the positive electrode 21 and the negative electrode 22 with use of each of the adhesion layers 23B and 23C while maintaining the shutdown function of the porous layer 23A. It is therefore possible to achieve superior safety.

In particular, the adhesion layers 23B and 23C may each include the homopolymer of vinylidene fluoride, the copolymer of vinylidene fluoride, or both. This improves the adherence of the adhesion layer 23B with respect to the positive electrode 21 and also improves the adherence of the adhesion layer 23C with respect to the negative electrode 22. It is therefore possible to achieve higher effects.

In this case, the adhesion layers 23B and 23C may each further include the insulating particles. This improves the adherence of the adhesion layer 23B with respect to the positive electrode 21 and also improves the adherence of the adhesion layer 23C with respect to the negative electrode 22. It is therefore possible to achieve further higher effects. Further, the content of the insulating particles in the adhesion layer 23B and the content of the insulating particles in the adhesion layer 23C may each be within the range from 30 vol % to 95 vol % both inclusive. This sufficiently improves the characteristic of entering and exiting of the lithium ions into/from each of the adhesion layers 23B and 23C and also sufficiently improves the adherence of each of the adhesion layers 23B and 23C, while securing the insulation resistance of each of the adhesion layers 23B and 23C. It is therefore possible to achieve markedly higher effects.

Further, the softening temperatures T4 and T5 of the adhesion layers 23B and 23C may satisfy the third physical property condition (T4≥70.0° C. and T5≥70.0° C.). This improves the characteristic of entering and exiting of the lithium ions into/from each of the adhesion layers 23B and 23C. It is therefore possible to achieve higher effects.

Further, the softening temperatures T4 and T5 of the adhesion layers 23B and 23C may satisfy the fourth physical property condition (T4≤100.0° C. and T5≤100.0° C.). This improves the adherence of the adhesion layer 23B with respect to the positive electrode 21 and also improves the adherence of the adhesion layer 23C to the negative electrode 22. It is therefore possible to achieve higher effects.

Further, the positive electrode 21 may include the lithium-nickel composite oxide, the solvent of the electrolytic solution may include the chain carboxylic acid ester, and the content of the chain carboxylic acid ester in the solvent may be within the range from 30 vol % to 60 vol % both inclusive. This improves the characteristic of entering and exiting of the lithium ions into/from each of the adhesion layers 23B and 23C and also improves the adherence of each of the adhesion layers 23B and 23C, while suppressing generation of gas due to the reaction between the lithium-nickel composite oxide and the electrolytic solution. It is therefore possible to achieve higher effects.

Further, the outer package film 10 may include the film members 10X and 10Y, and the bonding strength FA of the outer package film 10 may satisfy the above-described condition (FA≤0.50 N/mm). In such a case, the outer package film 10 is intentionally cleaved during the heating of the secondary battery. This further suppresses occurrence of a short circuit. It is therefore possible to achieve higher effects.

Further, the bonding strength FB of the outer package film 10 may satisfy the above-described condition (FB≥1.00 N/mm). This helps to prevent the outer package film 10 from being unintentionally cleaved during normal use of the secondary battery other than during the heating. It is therefore possible to achieve higher effects.

Further, the secondary battery may include a lithium-ion secondary battery. This makes it possible to obtain a sufficient battery capacity stably through the use of insertion and extraction of lithium. It is therefore possible to achieve higher effects.

A description is given next of a modification according to an embodiment. The configuration of the secondary battery described above is appropriately modifiable.

Specifically, the electrolytic solution that is a liquid electrolyte is used. However, although not specifically illustrated here, an electrolyte layer which is a gel electrolyte may be used instead of the electrolytic solution.

In the battery device 20 including the electrolyte layer, the positive electrode 21 and the negative electrode 22 are alternately stacked on each other with the separator 23 and the electrolyte layer interposed therebetween. The electrolyte layer is thus interposed between the positive electrode 21 and the separator 23, and between the negative electrode 22 and the separator 23.

The electrolyte layer includes a polymer compound together with the electrolytic solution. The electrolytic solution is held by the polymer compound. A reason for this is that leakage of the electrolytic solution is prevented. The configuration of the electrolytic solution is as described above. The polymer compound includes, for example, polyvinylidene difluoride. In a case of forming the electrolyte layer, a precursor solution including, for example, the electrolytic solution, the polymer compound, and a solvent is prepared, following which the precursor solution is applied on one side or both sides of the positive electrode 21 and on one side or both sides of the negative electrode 22.

When the electrolyte layer is used also, lithium ions are movable between the positive electrode 21 and the negative electrode 22 via the electrolyte layer, and similar effects are therefore obtainable. In this case, in particular, the leakage of the electrolytic solution is prevented as described above. It is therefore possible to achieve higher effects.

A description is given of applications (application examples) of the secondary battery.

The applications of the secondary battery are not particularly limited. The secondary battery used as a power source may serve as a main power source or an auxiliary power source of, for example, electronic equipment and an electric vehicle. The main power source is preferentially used regardless of the presence of any other power source. The auxiliary power source is used in place of the main power source, or is switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems or industrial battery systems for accumulation of electric power for a situation such as emergency. The above-described applications may each use one secondary battery, or may each use multiple secondary batteries.

The battery packs may each include a single battery, or may each include an assembled battery. The electric vehicle is a vehicle that operates (travels) using the secondary battery as a driving power source, and may be a hybrid automobile that is additionally provided with a driving source other than the secondary battery. In an electric power storage system for home use, electric power accumulated in the secondary battery serving as an electric power storage source may be utilized for using, for example, home appliances.

An application example of the secondary battery will now be described in detail. The configuration described below is merely an example, and is appropriately modifiable.

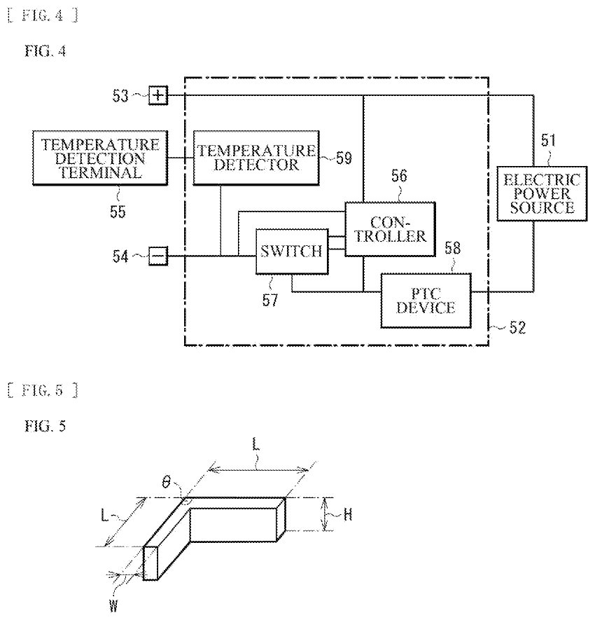

FIG. 4 illustrates a block configuration of a battery pack. The battery pack described here is a battery pack (what is called a soft pack) including one secondary battery, and is to be mounted on, for example, electronic equipment typified by a smartphone.

As illustrated in FIG. 4, the battery pack includes an electric power source 51 and a circuit board 52. The circuit board 52 is coupled to the electric power source 51, and includes a positive electrode terminal 53, a negative electrode terminal 54, and a temperature detection terminal 55.

The electric power source 51 includes one secondary battery. The secondary battery has a positive electrode lead coupled to the positive electrode terminal 53 and a negative electrode lead coupled to the negative electrode terminal 54. The electric power source 51 is coupled to outside via the positive electrode terminal 53 and the negative electrode terminal 54, and is thus chargeable and dischargeable. The circuit board 52 includes a controller 56, a switch 57, a thermosensitive resistive device (a PTC device) 58, and a temperature detector 59. However, the PTC device 58 may be omitted.

The controller 56 includes, for example, a central processing unit (CPU) and a memory, and controls an overall operation of the battery pack. The controller 56 detects and controls a use state of the electric power source 51 on an as-needed basis.

If a voltage of the electric power source 51 (the secondary battery) reaches an overcharge detection voltage or an overdischarge detection voltage, the controller 56 turns off the switch 57. This prevents a charging current from flowing into a current path of the electric power source 51. The overcharge detection voltage is not particularly limited, and is specifically 4.2 V±0.05 V. The overdischarge detection voltage is not particularly limited, and is specifically 2.4 V±0.1 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes, for example, a metal-oxide-semiconductor field-effect transistor (MOSFET). The charging and discharging currents are detected based on an ON-resistance of the switch 57.

The temperature detector 59 includes a temperature detection device such as a thermistor. The temperature detector 59 measures a temperature of the electric power source 51 using the temperature detection terminal 55, and outputs a result of the temperature measurement to the controller 56. The result of the temperature measurement to be obtained by the temperature detector 59 is used, for example, when the controller 56 performs charge and discharge control upon abnormal heat generation or when the controller 56 performs a correction process upon calculating a remaining capacity.

### EXAMPLES

A description is given of Examples of the present technology according to an embodiment.

### Examples 1 to 15 and Comparative Examples 1 and 2

Secondary batteries were fabricated, following which the secondary batteries were each evaluated for its characteristic.

### [Fabrication of Secondary Battery]

The secondary batteries (the lithium-ion secondary batteries of the laminated-film type) illustrated in FIGS. 1 to 3 were fabricated in accordance with the following procedure.

### (Fabrication of Positive Electrode)

First, 95 parts by mass of the positive electrode active material (lithium-nickel composite oxide (LiNi_{0.8}Co_{0.15}Al_{0.05}O₂)), 3 parts by mass of the positive electrode binder (polyvinylidene difluoride), and 2 parts by mass of the positive electrode conductor (Ketjen black that was amorphous carbon powder) were mixed with each other to thereby obtain a positive electrode mixture. Thereafter, the positive electrode mixture was put into a solvent (N-methyl-2-pyrrolidone that was the organic solvent), following which the organic solvent was stirred to thereby prepare a positive electrode mixture slurry in a paste form. Thereafter, the positive electrode mixture slurry was applied on the two opposed surfaces of the positive electrode current collector 21A (an aluminum foil, having a thickness of 10 μm) including the protruding part 21AT (but was not applied on the protruding part 21AT) by means of a coating apparatus, following which the applied positive electrode mixture slurry was dried to thereby form the positive electrode active material layers 21B. Lastly, the positive electrode active material layers 21B were compression-molded by means of a roll pressing machine. In this manner, the positive electrode 21 was fabricated.

### (Fabrication of Negative Electrode)

First, 95 parts by mass of the negative electrode active material (graphite that was the carbon material) and 5 parts by mass of the negative electrode binder (polyvinylidene difluoride) were mixed with each other to thereby obtain a negative electrode mixture. Thereafter, the negative electrode mixture was put into a solvent (N-methyl-2-pyrrolidone that was the organic solvent), following which the organic solvent was stirred to thereby prepare a negative electrode mixture slurry in a paste form. Thereafter, the negative electrode mixture slurry was applied on the two opposed surfaces of the negative electrode current collector 22A (a copper foil, having a thickness of 12 μm) including the protruding part 22AT (but was not applied on the protruding part 22AT) by means of a coating apparatus, following which the applied negative electrode mixture slurry was dried to thereby form the negative electrode active material layers 22B. Lastly, the negative electrode active material layers 22B were compression-molded by means of a roll pressing machine. In this manner, the negative electrode 22 was fabricated.

### (Fabrication of Separator)

Here, the separators 23 having respective 15 configurations (configurations A to O) as listed in Table 1 were fabricated.

First, the porous layer 23A (having a thickness of 10 μm) including the insulating polymer compound was prepared. Used as the polymer compound were polyethylene (PE), polypropylene (PP), and polyethylene and polypropylene (PE+PP). The porous layer 23A including polyethylene and polypropylene was a molded object obtained by melt-kneading polyethylene and polypropylene. The softening temperature T1 (° C.) of the porous layer 23A was as presented in Table 1.

Thereafter, the insulating polymer compound, the insulating particles (aluminum oxide (Al₂O₃) having a median diameter D50 of 500 nm), and a solvent (diethyl carbonate that was the organic solvent) were mixed with each other, following which the solvent was stirred to thereby prepare the precursor solution. Used as the polymer compound were the homopolymer of vinylidene fluoride (i.e., polyvinylidene difluoride (PVDF)) and the copolymer of vinylidene fluoride (i.e., a copolymer (PVDF(HFP)) of vinylidene fluoride and hexafluoropropylene in which a copolymerization amount of hexafluoropropylene was 34 wt %). The weight average molecular weight of the polymer compound and the content (vol %) of the insulating particles were as presented in Table 1.

Lastly, after the precursor solution was applied on the two opposed surfaces of the porous layer 23A, following which the precursor solution was dried to thereby form the adhesion layers 23B and 23C (each having a thickness of 2 μm). In this manner, the separator 23 was fabricated.

Note that the separator 23 (configuration P) was fabricated for comparison by a similar procedure except that the porous layer 23A including cellulose (CEL) was used. Further, the separator 23 (configuration Q) was fabricated for comparison by a similar procedure except that each of the adhesion layers 23B and 23C was not formed.

TABLE 1

| | | | Surface layer | | | | | | | |
|---|---|---|---|---|---|---|---|---|---|---|
| | | | | Weight | | | | | Adhesion | Temperature |
| | Porous layer | | | average | | | | | relationship | relationship |
| | Polymer | T1 | Polymer | molecular | Insulating | Content | T2, T3 | T4, T5 | F1 > F2 | T1 < T2 |
| | compound | (° C.) | compound | weight | particles | (vol %) | (° C.) | (° C.) | F3 > F4 | T1 < T3 |
| Configuration A | PE | 120.0 | PVDF | 250000 | Al₂O₃ | 67 | 139.2 | 55.0 | Satisfied | Satisfied |
| Configuration B | PE | 120.0 | PVDF | 500000 | Al₂O₃ | 67 | 139.0 | 62.6 | Satisfied | Satisfied |
| Configuration C | PE | 120.0 | PVDF | 1000000 | Al₂O₃ | 67 | 138.6 | 70.0 | Satisfied | Satisfied |
| Configuration D | PE | 120.0 | PVDF | 1700000 | Al₂O₃ | 67 | 139.0 | 77.4 | Satisfied | Satisfied |
| Configuration E | PE | 120.0 | PVDF | 2200000 | Al₂O₃ | 67 | 138.6 | 90.5 | Satisfied | Satisfied |
| Configuration F | PE | 120.0 | PVDF | 2600000 | Al₂O₃ | 67 | 138.6 | 93.0 | Satisfied | Satisfied |
| Configuration G | PE | 120.0 | PVDF | 1000000 | Al₂O₃ | 67 | 139.2 | 71.3 | Satisfied | Satisfied |
| | | | (HFP) | | | | | | | |
| Configuration H | PE | 120.0 | PVDF | 2200000 | Al₂O₃ | 67 | 139.5 | 90.5 | Satisfied | Satisfied |
| | | | (HFP) | | | | | | | |
| Configuration I | PE | 120.0 | PVDF | 2600000 | Al₂O₃ | 67 | 139.0 | 93.0 | Satisfied | Satisfied |
| | | | (HFP) | | | | | | | |
| Configuration J | PE | 120.0 | PVDF | 2600000 | Al₂O₃ | 80 | 139.0 | 100.0 | Satisfied | Satisfied |
| Configuration K | PE | 120.0 | PVDF | 2600000 | Al₂O₃ | 90 | 138.9 | 108.0 | Satisfied | Satisfied |
| Configuration L | PE | 120.0 | PVDF | 2600000 | Al₂O₃ | 95 | 138.5 | 117.2 | Satisfied | Satisfied |
| Configuration M | PE | 120.0 | PVDF | 1700000 | Al₂O₃ | 95 | 138.7 | 90.5 | Satisfied | Satisfied |
| Configuration N | PP | 140.0 | PVDF | 1700000 | Al₂O₃ | 67 | 148.0 | 77.0 | Satisfied | Satisfied |
| Configuration O | PE + PP | 135.0 | PVDF | 1700000 | Al₂O₃ | 67 | 139.0 | 77.1 | Satisfied | Satisfied |
| Configuration P | CEL | 250.0 | PVDF | 1700000 | Al₂O₃ | 67 | 178.0 | 77.9 | Unsatisfied | Unsatisfied |
| Configuration Q | PE | 120.0 | — | — | — | — | 138.0 | 138.6 | — | — |

After the separator 23 was fabricated, the secondary battery was fabricated by a procedure described below. After the secondary battery was completed, the secondary battery was disassembled and the separator 23 was collected to thereby examine the softening temperatures T2 to T5 (° C.) of the separator 23. The examination revealed the results presented in Table 1. In this case, the softening temperatures T2 to T5 were each varied by changing each of the weight average molecular weight of the polymer compound (PVDF) and the content of the insulating particles.

The “adhesion relationship” presented in Table 1 indicated: the relationship between the adhesion strength F1 of the adhesion layer 23B with respect to the positive electrode 21 and the adhesion strength F2 of the adhesion layer 23B with respect to the porous layer 23A; and the relationship between the adhesion strength F3 of the adhesion layer 23C with respect to the negative electrode 22 and the adhesion strength F4 of the adhesion layer 23C with respect to the porous layer 23A.

Specifically, when the relationship that the adhesion strength F1 was larger than the adhesion strength F2 and the adhesion strength F3 was larger than the adhesion strength F4 (F1>F2 and F3>F4) was satisfied, “satisfied” was written in the column of the “adhesion relationship”. In contrast, when the above-described relationship (F1>F2 and F3>F4) was not satisfied, “unsatisfied” was written in the column of the “adhesion relationship”.

Further, the “temperature relationship” presented in Table 1 indicated: the relationship between the softening temperature T1 of the porous layer 23A and the softening temperature T2 of the adhesion layer 23B, and also the relationship between the softening temperature T1 of the porous layer 23A and the softening temperature T3 of the adhesion layer 23C.

Specifically, when the relationship that the softening temperature T1 was lower than the softening temperature T2 and the softening temperature T1 was lower than the softening temperature T3 (T1<T2 and T1<T3) was satisfied, “satisfied” was written in the column of the “temperature relationship”. In contrast, when the above-described relationship (T1<T2 and T1<T3) was not satisfied, “unsatisfied” was written in the column of the “temperature relationship”.

### (Preparation of Electrolytic Solution)

The electrolyte salt (lithium hexafluorophosphate (LiPF₆)) was added to the solvent (ethylene carbonate that was the cyclic carbonic acid ester and propyl propionate that was the chain carbonic acid ester), following which the solvent was stirred. A mixture ratio (a weight ratio) of the solvent between ethylene carbonate and propyl propionate was set to 50:50. A content of the electrolyte salt was set to 1 mol/1 (=1 mol/dm³) with respect to the solvent. In this manner, the electrolytic solution was prepared.

### (Assembly of Secondary Battery)

First, multiple protruding parts 21AT were welded to each other, following which the positive electrode lead 31 (the aluminum foil) was welded to the welded protruding parts 21AT, and multiple protruding parts 22AT were welded to each other, following which the negative electrode lead 32 (the copper foil) was welded to the welded protruding parts 22AT.

Thereafter, the positive electrode 21 and the negative electrode 22 were stacked on each other with the separator 23 (a fine porous polyethylene film having a thickness of 25 μm) interposed therebetween to thereby fabricate a stacked body. Thereafter, the stacked body was pressed while being heated by means of a pressing machine. The positive electrode 21, the negative electrode 22, and the separator 23 were thereby thermocompression-bonded to each other.

Thereafter, the outer package film 10 (the fusion-bonding layer/the metal layer/the surface protective layer) was folded in such a manner as to sandwich the stacked body contained inside the depression part 10U. Thereafter, the respective outer edge parts of two sides of the fusion-bonding layers of the film members 10X and 10Y were thermal-fusion-bonded to each other to thereby allow the stacked body to be contained inside the outer package film 10 having the pouch shape. As the outer package film 10, an aluminum laminated film was used in which a fusion-bonding layer (a polypropylene film having a thickness of 30 μm), a metal layer (an aluminum foil having a thickness of 40 μm), and a surface protective layer (a nylon film having a thickness of 25 μm) were stacked in this order from an inner side.

Lastly, the electrolytic solution was injected into the outer package film 10 having the pouch shape and thereafter, the respective outer edge parts of the remaining one side of the fusion-bonding layers of the film members 10X and 10Y were thermal-fusion-bonded to each other in a reduced-pressure environment. In this case, the sealing film 41 (a polypropylene film having a thickness of 5 μm) was interposed between each of the film members 10X and 10Y and the positive electrode lead 31, and the sealing film 42 (a polypropylene film having a thickness of 5 μm) was interposed between each of the film members 10X and 10Y and the negative electrode lead 32.

In this manner, the stacked body was impregnated with the electrolytic solution, and the battery device 20 was thus fabricated. Accordingly, the battery device 20 was sealed in the outer package film 10. As a result, the secondary battery was assembled.

### (Stabilization of Secondary Battery)

The secondary battery was charged and discharged for one cycle in an ambient temperature environment (at a temperature of 25° C.±5° C.). Upon charging, the secondary battery was charged with a constant current of 0.1 C until a voltage reached 4.2 V, and was thereafter charged with a constant voltage of 4.2 V until a current reached 0.05 C. Upon discharging, the secondary battery was discharged with a constant current of 0.1 C until the voltage reached 3.0 V. Note that 0.1 C was a value of a current that caused a battery capacity (a theoretical capacity) to be completely discharged in 10 hours, and 0.05 C was a value of a current that caused the battery capacity to be completely discharged in 20 hours.

A film was thereby formed on the surface of each of the positive electrode 21 and the negative electrode 22. This brought the secondary battery into an electrochemically stable state. As a result, the secondary battery was completed.

### [Evaluation of Characteristic of Secondary Battery]

The secondary batteries were each evaluated for safety as its characteristic. The evaluation results are presented in Table 2. Here, the secondary battery was used to perform a heating test and a short-circuit test to thereby determine a state of the secondary battery after the tests.

### (Heating Test)

First, the secondary battery was discharged in an ambient temperature environment (at a temperature of 25° C.±5° C.), and was thereafter charged. Upon discharging, the secondary battery was discharged with a current of 0.5 C until a voltage reached 3.0 V. Upon charging, the secondary battery was charged with a constant current of 0.2 C until the voltage reached 4.25 V, and was thereafter charged with a constant voltage of 4.25 V until a total charging time reached 6 hours. Note that 0.5 C was a value of a current that caused a battery capacity to be completely discharged in 2 hours, and 0.2 C was a value of a current that caused the battery capacity to be completely discharged in 5 hours.

Thereafter, the charged secondary battery was put into an oven to thereby heat the secondary battery. In this case, the temperature in the oven was increased to reach 140° C.±2° C. at a temperature increase rate of 5° C.±2° C./min. Further, after the temperature inside the oven reached 140° C.±2° C., the secondary battery was stored in the oven (for a storing time of 60 minutes).

Lastly, a state of the secondary battery after the heating was visually checked to thereby determine the state of the secondary battery. Specifically, when neither ignition nor smoke generation occurred, it was determined that superior safety was obtained, and the state of the secondary battery was thus determined as “A”. When no ignition occurred but smoke was generated, it was determined that safety within an allowable range was obtained, and the state of the secondary battery was thus determined as “B”. When the ignition occurred, it was determined that superior safety was not obtained, and the state of the secondary battery was thus determined as “C”.

In the heating test described here, a reason why the ignition occurred in the secondary battery was that the secondary battery was heated under a markedly severe condition (at a temperature of 140° C.±2° C.) in order to make a difference between the ignition and the non-ignition to occur easily. In other words, in order to make it easier to verify the ignition and the non-ignition, some type of an acceleration test was performed from a viewpoint of safety of the secondary battery.

### (Short-Circuit Test)

A short-circuit test was performed by a procedure defined by JIS C8714. Specifically, first, the secondary battery was discharged and charged by a procedure similar to that of the heating test described above, following which the charged secondary battery was disassembled to thereby collect the battery device 20.

Thereafter, the battery device 20 was disassembled to thereby collect the positive electrode 21, the negative electrode 22, and the separator 23, following which a nickel piece was placed between the positive electrode 21 and the separator 23 and another nickel piece was placed between the negative electrode 22 and the separator 23. As illustrated in FIG. 5, those nickel pieces each had a three-dimensional shape in which two extending parts extending in respective directions orthogonal to each other were coupled to each other. Each of the extending parts had a length L of 1 mm, a height H of 0.2 mm, and a width W of 0.1 mm. The two extending parts had a coupling angle θ of 90°.

Thereafter, the positive electrode 21, the negative electrode 22, and the separator 23 were thermocompression-bonded to each other using a procedure similar to the fabrication process of the secondary battery (the thermocompression-bonding process of the stacked body) to thereby fabricate the battery device 20 again.

Thereafter, the battery device 20 was contained in a polyethylene bag, following which pressure was applied to the battery device 20 contained inside the polyethylene bag with use of a pressure-application jig (having a size of a pressure-application surface of 10 mm×10 mm). In this case, the pressure was applied to the battery device 20 at a location where the nickel piece was placed while measuring the voltage of the battery device 20, and thus the pressure was continued to be applied to the battery device 20 until a voltage drop occurred.

Lastly, a state of the secondary battery after the pressure application was visually checked to thereby determine the state of the secondary battery based on a standard similar to a determination standard used for the heating test.

In the short-circuit test described here, a reason why the ignition occurred in the secondary battery was that, as with the case described for the heating test, a short-circuit was forcibly caused in the secondary battery under a markedly severe condition (use of the nickel piece), in other words, some type of an acceleration test was performed.

### (Measurement of Discharge Capacity)

Here, four kinds of discharge capacities related to the secondary battery were also measured. A value of the discharge capacity was rounded off to one decimal place.

First, the secondary battery was charged and discharged for one cycle in an ambient temperature environment (at a temperature of 25° C.±5° C.) to thereby measure a first-cycle discharge capacity. Upon charging, the secondary battery was charged with a constant current of 2 C until a voltage reached 4.2 V, and was thereafter charged with a constant voltage of 4.2 V until a current reached 0.05 C. Upon discharging, the secondary battery was discharged with a constant current of 0.2 C until the voltage reached 2.5 V.

Second, the above-described secondary battery that had been charged and discharged for one cycle was repeatedly charged and discharged for 499 cycles in an ambient temperature environment to thereby measure a 500th-cycle discharge capacity. Charging and discharging conditions were similar to the charging and discharging conditions of the first cycle.

Third, the first-cycle discharge capacity was measured by a similar procedure except that the current at the time of charging and the current at the time of discharging were each changed to C. Note that 5 C was a value of a current that caused the battery capacity to be completely discharged in 0.2 hours.

Fourth, the 500th-cycle discharge capacity was measured by a similar procedure except that the current at the time of charging and the current at the time of discharging were each changed to 5 C.

In Table 2, a discharge capacity based on when the current at the time of charging and the current at the time of discharging were each set to 0.2 C was presented as “discharge capacity (0.2 C)”, and a discharge capacity based on when the current at the time of charging and the current at the time of discharging were each set to 5 C was presented as “discharge capacity (5 C)”.

Further, the respective values of the discharge capacity (0.2 C) and the discharge capacity (5 C) presented in Table 2 were each a normalized value obtained by setting the value of the first-cycle discharge capacity (0.2 C) to 100.0.

TABLE 2

| | | | | | Discharge | | Discharge | | | |
|---|---|---|---|---|---|---|---|---|---|---|
| | | | Adhesion | Temperature | capacity | | capacity | | | Short-circuit |
| | Separator | | relationship | relationship | (0.2 C) | | (5 C) | | Heating test | test |
| | | T4, T5 | F1 > F2 | T1 < T2 | First | 500th | First | 500th | Determination | Determination |
| | Configuration | (° C.) | F3 > F4 | T1 < T3 | cycle | cycle | cycle | cycle | result | result |
| Example 1 | Configuration A | 55.0 | Satisfied | Satisfied | 100.0 | 90.2 | 99.0 | 57.5 | A | A |
| Example 2 | Configuration B | 62.6 | Satisfied | Satisfied | 100.0 | 90.1 | 99.1 | 68.2 | A | A |
| Example 3 | Configuration C | 70.0 | Satisfied | Satisfied | 100.0 | 89.5 | 98.7 | 70.0 | A | A |
| Example 4 | Configuration D | 77.4 | Satisfied | Satisfied | 100.0 | 88.9 | 98.8 | 82.5 | A | A |
| Example 5 | Configuration E | 90.5 | Satisfied | Satisfied | 100.0 | 90.4 | 98.9 | 83.4 | A | A |
| Example 6 | Configuration F | 93.0 | Satisfied | Satisfied | 100.0 | 89.6 | 99.2 | 83.0 | A | A |
| Example 7 | Configuration G | 71.3 | Satisfied | Satisfied | 100.0 | 89.7 | 99.3 | 82.7 | A | A |
| Example 8 | Configuration H | 90.5 | Satisfied | Satisfied | 100.0 | 88.9 | 98.8 | 81.9 | A | A |
| Example 9 | Configuration I | 93.0 | Satisfied | Satisfied | 100.0 | 90.1 | 98.7 | 83.1 | A | A |
| Example 10 | Configuration J | 100.0 | Satisfied | Satisfied | 100.0 | 89.5 | 98.7 | 81.5 | A | A |
| Example 11 | Configuration K | 108.0 | Satisfied | Satisfied | 100.0 | 88.9 | 98.6 | 82.7 | B | A |
| Example 12 | Configuration L | 117.2 | Satisfied | Satisfied | 100.0 | 89.2 | 99.0 | 82.9 | B | A |
| Example 13 | Configuration M | 90.5 | Satisfied | Satisfied | 100.0 | 89.5 | 99.2 | 82.4 | A | A |
| Example 14 | Configuration N | 77.0 | Satisfied | Satisfied | 100.0 | 90.0 | 99.1 | 82.1 | A | A |
| Example 15 | Configuration O | 77.1 | Satisfied | Satisfied | 100.0 | 90.2 | 99.1 | 82.4 | A | A |
| Comparative | Configuration P | 77.9 | Unsatisfied | Unsatisfied | 100.0 | 89.7 | 99.1 | 82.2 | C | C |
| example 1 | | | | | | | | | | |
| Comparative | Configuration Q | 138.6 | — | — | 100.0 | 89.6 | 99.3 | 85.3 | C | C |
| example 2 | | | | | | | | | | |

As presented in Table 2, the respective determination results of the heating test and the short-circuit test varied greatly depending on the configuration of the separator 23.

Specifically, if the separator 23 that included neither the adhesion layer 23B nor the adhesion layer 23C was used (Comparative example 2), the ignition occurred in both the heating test and the short-circuit test.

Even if the separator 23 that included the adhesion layers 23B and 23C was used, the ignition also occurred in both the heating test and the short-circuit test if neither the adhesion relationship (F1>F2 and F3>F4) nor the temperature relationship (T1<T2 and T1<T3) was satisfied (Comparative example 1).

However, if the separator 23 including the adhesion layers 23B and 23C was used and if both the adhesion relationship (F1>F2 and F3>F4) and the temperature relationship (T1<T2 and T1<T3) were satisfied (Examples 1 to 15), no ignition occurred in both the heating test and the short-circuit test.

In this case, if the softening temperatures T4 and T5 were each higher than or equal to 70.0° C. in particular, the 500th-cycle discharge capacity (5 C) further increased. In addition, if the softening temperatures T4 and T5 that were each higher than or equal to 70.0° C. were each lower than or equal to 100° C., no smoke generation occurred.

### Examples 16 to 26

As presented in Table 3, secondary batteries were fabricated by a similar procedure except that the configuration (the content and the kind of the insulating particles) of each of the adhesion layers 23B and 23C was changed. The configuration of the separator 23 was set to the configuration D. Thereafter, the secondary batteries were each evaluated for its characteristic (the heating test and the short-circuit test). Here, new insulating particles (boehmite (AlOOH)) were also used.

TABLE 3
Configuration of separator = configuration D

| | | | | | | | Discharge | | Discharge | | | |
|---|---|---|---|---|---|---|---|---|---|---|---|---|
| | | | | | Adhesion | Temperature | capacity | | capacity | | | Short-circuit |
| | Surface layer | | | | relationship | relationship | (0.2 C) | | (5 C) | | Heating test | test |
| | Insulating | Content | T2, T3 | T4, T5 | F1 > F2 | T1 < T2 | First | 500th | First | 500th | Determination | Determination |
| | particles | (vol %) | (° C.) | (° C.) | F3 > F4 | T1 < T3 | cycle | cycle | cycle | cycle | result | result |
| Example 16 | Al₂O₃ | 10 | 139.2 | 53.9 | B | B | 100.0 | 90.2 | 99.0 | 51.1 | B | B |
| Example 17 | Al₂O₃ | 20 | 139.0 | 60.2 | B | B | 100.0 | 90.1 | 99.1 | 60.9 | B | B |
| Example 18 | Al₂O₃ | 30 | 138.6 | 69.7 | A | A | 100.0 | 89.5 | 98.7 | 81.8 | A | A |
| Example 19 | Al₂O₃ | 50 | 139.0 | 73.3 | A | A | 100.0 | 88.9 | 98.8 | 82.3 | A | A |
| Example 4 | Al₂O₃ | 67 | 139.0 | 77.4 | A | A | 100.0 | 88.9 | 98.8 | 82.5 | A | A |
| Example 20 | Al₂O₃ | 70 | 138.6 | 78.1 | A | A | 100.0 | 90.4 | 98.9 | 83.3 | A | A |
| Example 21 | Al₂O₃ | 80 | 138.6 | 83.9 | A | A | 100.0 | 89.6 | 99.2 | 83.1 | A | A |
| Example 22 | Al₂O₃ | 90 | 139.2 | 88.8 | A | A | 100.0 | 89.7 | 99.3 | 82.9 | A | A |
| Example 23 | Al₂O₃ | 95 | 139.5 | 90.5 | A | A | 100.0 | 88.9 | 98.8 | 83.0 | A | A |
| Example 24 | Al₂O₃ | 99 | 139.0 | 96.5 | A | A | 100.0 | 90.1 | 98.7 | 80.1 | B | A |
| Example 25 | AlOOH | 70 | 139.0 | 69.1 | B | A | 100.0 | 89.5 | 98.7 | 83.4 | B | A |
| Example 26 | AlOOH | 95 | 138.9 | 90.1 | A | A | 100.0 | 88.0 | 98.1 | 81.1 | A | A |

As presented in Table 3, no ignition occurred in both the heating test and the short-circuit test even if the content and the kind of the insulating particles were changed. In this case, if the content of the insulating particles was within the range from 30 vol % to 95 vol % both inclusive in particular, no smoke generation occurred and the 500th-cycle discharge capacity (5 C) further increased.

### Examples 27 to 33

As presented in Table 4, secondary batteries were fabricated by a similar procedure except that the bonding strengths FA and FB (N/mm) of the outer package film 10 were changed. The configuration of the separator 23 was set to the configuration D. Thereafter, the secondary batteries were each evaluated for its characteristic.

Here, a storage test was performed instead of the short-circuit test described above. In the storage test, the secondary battery was stored (for a storing time of 5 hours) in an oven (at a temperature of 100° C.), following which a state of the secondary battery after the storage was visually checked to thereby determine the state of the secondary battery.

Specifically, when the outer package film 10 was not cleaved at a location where the film members 10X and 10Y were thermal-fusion-bonded to each other, it was determined that the outer package film 10 obtained sufficient sealing durability, and the state of the secondary battery was thus determined as “A”. In contrast, when the outer package film 10 was cleaved, it was determined that the outer package film 10 did not obtain the sufficient sealing durability, and the state of the secondary battery was thus determined as “B”.

TABLE 4
Configuration of separator = configuration D

| | | | Discharge | | Discharge | | | |
|---|---|---|---|---|---|---|---|---|
| | Outer package | | capacity | | capacity | | | |
| | film | | (0.2 C) | | (5 C) | | Heating test | Storage test |
| | FA | FB | First | 500th | First | 500th | Determination | Determination |
| | (N/mm) | (N/mm) | cycle | cycle | cycle | cycle | result | result |
| Example 27 | 0.29 | 0.89 | 100.0 | 88.9 | 98.8 | 82.9 | A | B |
| Example 28 | 0.32 | 0.94 | 100.0 | 89.5 | 98.7 | 83.0 | A | B |
| Example 29 | 0.36 | 1.15 | 100.0 | 90.1 | 99.1 | 83.5 | A | A |
| Example 30 | 0.44 | 0.85 | 100.0 | 89.4 | 99.1 | 83.2 | A | B |
| Example 4 | 0.45 | 1.52 | 100.0 | 90.2 | 99.0 | 82.4 | A | A |
| Example 31 | 0.50 | 1.00 | 100.0 | 89.7 | 99.3 | 83.4 | A | A |
| Example 32 | 0.76 | 1.33 | 100.0 | 89.6 | 99.2 | 80.1 | B | A |
| Example 33 | 1.01 | 1.67 | 100.0 | 90.4 | 98.9 | 83.0 | B | A |

As presented in Table 4, no ignition occurred in the secondary battery in the heating test even if the bonding strengths FA and FB were changed. In this case, if the bonding strength FA was smaller than or equal to 0.50 N/mm in particular, the smoke generation did not occur either, and if the bonding strength FB was larger than or equal to 1.00 N/mm, the outer package film 10 was prevented from being unintentionally cleaved.

### Examples 34 to 37

As presented in Table 5, secondary batteries were fabricated by a similar procedure except that the composition of the electrolytic solution (the content (vol %) of the chain carboxylic acid ester in the solvent) was changed. The configuration of the separator 23 was set to the configuration D. Thereafter, the secondary batteries were each evaluated for its characteristic (the heating test and the storage test).

TABLE 5
Configuration of separator = configuration D

| | Chain | | Discharge | | Discharge | | | |
|---|---|---|---|---|---|---|---|---|
| | carboxylic | | capacity | | capacity | | | |
| | acid ester | | (0.2 C) | | (5 C) | | Heating test | Storage test |
| | | Content | First | 500th | First | 500th | Determination | Determination |
| | Kind | (vol %) | cycle | cycle | cycle | cycle | result | result |
| Example 34 | PP | 20 | 98.0 | 88.6 | 97.5 | 56.7 | B | B |
| Example 35 | PP | 30 | 98.1 | 90.0 | 97.6 | 58.5 | A | A |
| Example 4 | PP | 50 | 100.0 | 90.2 | 99.0 | 82.4 | A | A |
| Example 36 | PP | 60 | 98.1 | 90.0 | 97.9 | 65.5 | A | A |
| Example 37 | PP | 70 | 97.0 | 86.9 | 95.1 | 52.5 | B | A |

As presented in Table 5, no ignition occurred even if the content of the chain carboxylic acid ester in the solvent was changed. In this case, if the content of the chain carboxylic acid ester was within the range from 30 vol % to 60 vol % both inclusive in particular, the discharge capacity (0.2 C) and the discharge capacity (5 C) each further increased, the smoke generation did not occur, and the outer package film 10 was prevented from being unintentionally cleaved.

Based upon the results presented in Tables 1 to 5, satisfactory results were obtained in the heating test and the short-circuit test if: the separator 23 included the porous layer 23A, the adhesion layer 23B adhered to the positive electrode 21, and the adhesion layer 23C adhered to the negative electrode 22; the adhesion strengths F1 to F4 of the adhesion layers 23B and 23C satisfied the first physical property condition (F1>F2 and F3>F4); and the softening temperatures T1 to T3 of the porous layer 23A and the adhesion layers 23B and 23C satisfied the second physical property condition (T1<T2 and T1<T3). It was therefore possible for the secondary battery to achieve superior safety.

Although the present technology has been described herein with reference to one or more embodiments including Examples, the configuration of the present technology is not limited thereto, and is therefore modifiable in a variety of suitable ways.

For example, the description has been given of the case where the secondary battery has a battery structure of the laminated-film type. However, the battery structure of the secondary battery is not particularly limited, and may be, for example, a cylindrical type, a prismatic type, a coin type, or a button type.

Further, the description has been given of the case where the battery device has a device structure of a stacked type. However, the device structure of the battery device is not particularly limited. The device structure may be, for example, a wound type or a zigzag folded type. In the battery device having the device structure of the wound type, the positive electrode and the negative electrode are opposed to each other with the separator interposed therebetween, and are wound. In the battery device having the device structure of the zigzag folded type, the positive electrode and the negative electrode are opposed to each other with the separator interposed therebetween, and are folded in a zigzag manner.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other suitable effect.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode; and
a separator interposed between the positive electrode and the negative electrode, wherein
the separator includes
a porous layer,
a first adhesion layer provided between the porous layer and the positive electrode, the first adhesion layer being adhered to the positive electrode, and
a second adhesion layer provided between the porous layer and the negative electrode, the second adhesion layer being adhered to the negative electrode,
after the separator is heated at a heating temperature of within plus or minus 5 degrees Celsius of 130 degrees Celsius for a heating time of one hour, an adhesion strength of the first adhesion layer with respect to the positive electrode is larger than an adhesion strength of the first adhesion layer with respect to the porous layer, and an adhesion strength of the second adhesion layer with respect to the negative electrode is larger than an adhesion strength of the second adhesion layer with respect to the porous layer, and
after the separator is heated at a heating temperature of within plus or minus 5 degrees Celsius of 130 degrees Celsius for a heating time of one hour, a softening temperature of the porous layer is lower than a softening temperature of the first adhesion layer, and is lower than a softening temperature of the second adhesion layer.

2. The secondary battery according to claim 1, wherein the first adhesion layer and the second adhesion layer each include a homopolymer of vinylidene fluoride, a copolymer of vinylidene fluoride, or both.

3. The secondary battery according to claim 2, wherein the first adhesion layer and the second adhesion layer each further include insulating particles.

4. The secondary battery according to claim 3, wherein a content of the insulating particles in the first adhesion layer and a content of the insulating particles in the second adhesion layer are each greater than or equal to 30 volume percent and less than or equal to 95 volume percent.

5. The secondary battery according to claim 1, wherein, after the separator is impregnated with propylene carbonate for an impregnation time of 24 hours, the softening temperature of the first adhesion layer and the softening temperature of the second adhesion layer are each higher than or equal to 70.0 degrees Celsius.

6. The secondary battery according to claim 1, wherein, after the separator is impregnated with propylene carbonate for an impregnation time of 24 hours, the softening temperature of the first adhesion layer and the softening temperature of the second adhesion layer are each lower than or equal to 100.0 degrees Celsius.

7. The secondary battery according to claim 1, further comprising
an electrolytic solution including a solvent, wherein
the positive electrode includes a lithium-nickel composite oxide represented by Formula (1) below,
the solvent includes a chain carboxylic acid ester, and
a content of the chain carboxylic acid ester in the solvent is greater than or equal to 30 volume percent and less than or equal to 60 volume percent,
LiₓNi_{y}M_{1-y}O_{z} (1)
where
M is at least one of Co, Mn, Mg, Al, B, Ti, V, Cr, Fe, Cu, Zn, Mo, Sn, Ca, Sr, or W, and
x, y, and z satisfy 0.8≤x≤1.2, 0.8≤y≤1.0, and 0<z<3.

8. The secondary battery according to claim 1, further comprising
an outer package member having flexibility that contains the positive electrode, the negative electrode, and the separator, wherein
the outer package member includes a pair of outer package parts, the pair of outer package parts being opposed to each other with the positive electrode, the negative electrode, and the separator being interposed between the pair of outer package parts, the pair of outer package parts having respective outer edge parts that are bonded to each other, and
after the outer package member is heated at a heating temperature of within plus or minus degrees Celsius of 130 degrees Celsius for a heating time of 0.5 hours, a bonding strength at which the outer edge parts are bonded to each other is smaller than or equal to 0.50 newtons per millimeter.

9. The secondary battery according to claim 1, further comprising
an outer package member having flexibility that contains the positive electrode, the negative electrode, and the separator, wherein
the outer package member includes a pair of outer package parts, the pair of outer package parts being opposed to each other with the positive electrode, the negative electrode, and the separator being interposed between the pair of outer package parts, the pair of outer package parts having respective outer edge parts that are bonded to each other, and
a bonding strength at which the outer edge parts are bonded to each other at a temperature of higher than or equal to within plus or minus 5 degrees Celsius of 25 degrees Celsius is larger than or equal to 1.00 newtons per millimeter.

10. The secondary battery according to claim 1, wherein the secondary battery comprises a lithium-ion secondary battery.
